(19) United States
(12) Patent Application Publication
(10) Pub. No.: US 2025/0216185 A1
(43) Pub. Date: Jul. 3, 2025

(54) ANGLE GAUGE WITH ADJUSTABLE ANGLE AND KNIFE SHARPENER HAVING SAME

(71) Applicant: Shanghai Everex Industries Co., Ltd., Shanghai (CN)

(72) Inventor: Jianhua Wang, Shanghai (CN)

(21) Appl. No.: 18/989,165

(22) Filed: Dec. 20, 2024

(30) Foreign Application Priority Data
Dec. 27, 2023 (CN) 202323613976.X
Dec. 27, 2023 (CN) 2023118343429

(51) Int. Cl. G01B 3/56; B24D 15/08

(52) U.S. Cl. CPC G01B 3/56; B24D 15/08

(57) ABSTRACT

The present disclosure provides an angle gauge with an adjustable angle and a knife sharpener having the same. The angle gauge includes at least one set of angle adjustment mechanisms. Each set of angle adjustment mechanisms includes a first support, a first inclined surface-equipped member, and an angle adjustment member. The first inclined surface-equipped member is provided with a first inclined surface for sharpening a knife. The angle adjustment member is provided with a second inclined surface. The first inclined surface-equipped member is rotatably connected to the first support. Through movement of the angle adjustment member, the second inclined surface drives an end of the first inclined surface-equipped member to rise or fall, to adjust an inclination angle of the first inclined surface.

### TECHNICAL FIELD

The present disclosure relates to the field of knife sharpeners, and in particular, to an angle gauge with an adjustable angle and a knife sharpener having the same.

### BACKGROUND

Current iterations of knife sharpening tools incorporate knife sharpening rods and an inclined surface forming an initial knife sharpening angle at a fixed position. For many of these knife sharpening tools, the inclination angles are fixed and cannot be adjusted. If the angle of the inclined surface cannot be precisely adjusted, sharpening angle requirements of various knives cannot be met.

Further, existing knife sharpeners lack modularity and have only one knife sharpening function (for example, coarse sharpening, fine sharpening, or polishing). Users must therefore purchase multiple knife sharpening devices to match each desired knife sharpening function.

Additionally, existing knife sharpeners include a handle and the knife sharpening rod which are integrally connected as a whole. This configuration leads to a larger volume and, as a result, is an inconvenience to store or carry around.

Finally, a user may require an instrument with the capacity to sharpen an arrowhead and/or remove the arrowhead from the shaft of an arrow. Existing knife sharpeners do not incorporate a means to remove an arrowhead from the shaft of the arrow (such as by twisting or other means).

In view of the foregoing, a need exists for an improved angle gauge and knife sharpener with: an adjustable sharpening angle; a plurality of sharpening functions; a reduced volume; and the added function of twisting an arrowhead.

### SUMMARY

The present disclosure is directed to an angle gauge with an adjustable sharpening angle (and a corresponding knife sharpener having the same). The present disclosure provides users with an adjustable sharpening angle. The knife sharpener is compact in size, provides users with a plurality of sharpening functions, and may be used to twist an arrowhead.

In an embodiment of the present disclosure, the angle gauge includes an angle adjustment mechanism. The angle adjustment mechanism includes a first support, a first inclined surface-equipped member, and an angle adjustment member. The first inclined surface-equipped member includes a first inclined surface for sharpening a knife, and the angle adjustment member is provided with a second inclined surface.

The first inclined surface-equipped member is rotatably connected to the first support. Through movement of the angle adjustment member, the second inclined surface drives an end of the first inclined surface-equipped member to adjust an inclination angle of the first inclined surface.

In an embodiment, the angle gauge also includes a first angle adjustment knob and the angle adjustment member is a push tube. The first angle adjustment knob and the push tube are threadedly connected to achieve axial movement of the push tube.

In an embodiment, the push tube includes four second inclined surfaces and each of the second inclined surfaces corresponds to one first inclined surface-equipped member, and the four first inclined surface-equipped members are distributed on four sides of the first support.

Further, the four first inclined surface-equipped members are all connected to a fourth elastic member.

In an embodiment, the push tube includes two second inclined surfaces and each of the second inclined surfaces corresponds to one first inclined surface-equipped member, and the two first inclined surface-equipped members are distributed on two sides of the first support.

In an embodiment, the first support includes a plurality of first positioning grooves and the angle adjustment member is a push block. The push block includes an elastic pressing portion and the elastic pressing portion is connected to a bump. The bump matches the corresponding first positioning groove to achieve positioning of the push block after movement.

In an embodiment, a second elastic member is disposed between the push block and the elastic pressing portion. The plurality of first positioning grooves are arranged corresponding to first identifiers. The first inclined surface-equipped member includes an extension and the extension is connected to an end of a third elastic member. A second end of the third elastic member abuts against the inner side wall of the first support and the elastic pressing portion is embedded in a first guide groove.

In an embodiment, the first inclined surface-equipped member comprises a higher end and a lower end. The second inclined surface engages the bottom portion of a higher end to adjust the inclination angle of the first inclined surface.

In an embodiment, the first support has a hollow interior and includes a first mounting groove. The first inclined surface-equipped member is partially disposed within the first mounting groove and is connected to a connecting shaft.

In an embodiment, the outer side surface of the push tube includes a first external thread and the top portion of the push tube is disposed within the hollow portion of the first support such that the second inclined surface is in contact with the first inclined surface-equipped member. The first angle adjustment knob includes a first internal thread which is aligned in registration with the first external thread.

In an embodiment, the first support also includes a first elastic member configured to drive the first inclined surface-equipped member to a reset position. The first support also includes a hollowed-out guide groove, a first identifier displaying an angle value adjacent a side of the first guide groove, a second identifier displaying a rotation direction for the first angle adjustment knob, and a first connecting groove disposed along the top of the first support. In an embodiment, the second identifier is adjacent a side of the first guide groove.

In an embodiment, the push tube also includes a first protruding block which is partially disposed within the first guide groove and moves in synchrony within the first guide groove with the axial movement of the push tube.

In an embodiment, the first support also includes a first elastic member configured to drive the first inclined surface-equipped member to a reset position, an indication portion proximate a bottom edge of the first support and corresponding to a third identifier disposed along the outer side surface of the first angle adjustment knob. A first connecting groove is disposed along the top of the first support.

Further, the angle gauge includes two sets of angle adjustment mechanisms, or three sets of angle adjustment mechanisms, or five sets of angle adjustment mechanisms, or six sets of angle adjustment mechanisms, or eight sets of angle adjustment mechanisms.

The present disclosure also includes a knife sharpener which incorporates the angle gauge(s) discussed above. In an embodiment, the first support is connected to a knife sharpening portion, and the first inclined surface is configured to provide a knife sharpening angle for sharpening a knife on the knife sharpening portion.

In an embodiment, the knife sharpening portion includes a knife sharpening support and a knife sharpening rod. The knife sharpening support includes an open groove for mounting the knife sharpening rod. The knife sharpening support may also include a receiving space for storing the knife sharpening rod within the knife sharpening support. A third knob may be included proximate the top end of the knife sharpening support.

In an embodiment, a layer of cowhide may be applied to an outer surface of the knife sharpening support.

In an embodiment, the bottom end of the knife sharpening support is connected to the first support via a third connecting member.

In an embodiment, the knife sharpening support includes two layers of cowhide disposed of two surfaces of the knife sharpening support. Two open grooves are adjacent the edges of each layer of cowhide. A receiving hole is disposed within and extending through the knife sharpening support. The receiving hole includes a tapered rod receiving hole which is detachably connected to the third knob at a first end of the receiving hole. The receiving hole is connected to a third connecting member at a second end of the receiving hole.

In an embodiment, the third connecting member is divided into a connecting section A and a connecting section B. The connecting section A is embedded within the second end of the receiving hole to form the connection between the third connecting member and the knife sharpening support. Connecting section A has an outer side surface comprised of at least one of the following: a jagged portion, anti-slip teeth, and/or a knurled portion.

In an embodiment, a first knob projects from the first support in a radial direction and is aligned in registration with a third mounting hole to form a connection between the third connecting member and first support. A first through hole extends from a side surface of the first support to the first connecting groove. In an embodiment, the first through hole has a second internal thread. In an embodiment, the first knob comprises a first knob cap connected to an end of a screw rod and a second external thread disposed along an outer side wall of the first knob cap. In an embodiment, the second external thread is aligned in registration with the second internal thread.

In an embodiment, a gasket is disposed between the connecting section A and connecting section B. The knurled portion is located at a position on the connecting section A proximate the gasket.

In an embodiment, the first connecting groove includes a fourth internal thread disposed on the interior surface of the first connecting groove. The third connecting member includes a fourth external thread disposed on the outer surface of the connecting section B. In an embodiment, the fourth internal thread is aligned in registration with the fourth external thread to achieve the connection between the first support and the third connecting member. A bottom portion of the first support may include a first boss portion. The first boss portion is embedded into the inner side wall of a top portion of the first angle adjustment knob. In an embodiment, a handle is connected to a bottom portion of the first angle adjustment knob.

In an embodiment, the handle includes a fourth receiving space capable of storing the knife sharpening portion. In addition, the end of the handle opposite the angle adjustment knob is connected to an end cap. The end cap includes a plurality of arrow twisting teeth. The arrow twisting teeth form a fourth hollowed-out portion for removing an arrowhead from the shaft of an arrow.

In view of the above technical features, the present disclosure ensures precise and consistent sharpening, accommodating various sharpening needs such as coarse grinding, fine honing, and polishing. This design allows users to maintain the ideal sharpening angle, enhancing edge performance for different tools. The integrated internal storage organizes all components efficiently, making the sharpener portable and suitable for outdoor applications. Specifically, the present disclosure includes the following beneficial effects:

1. The inclination angle of the first inclined surface can be adjusted as long as the angle adjustment member is moved, which is simple and convenient to use. This design of the adjustable angle gauge meets the various angle requirements for knife sharpening without the need to replace the angle gauge or the entire knife sharpener, thereby saving costs.

2. The device may incorporate a first elastic member which is disposed between the first support and the first inclined surface-equipped member. When the first angle adjustment knob is rotated to reduce the angle, the elastic member helps the first inclined surface automatically retract until the first inclined surface is reset, without a need for an additional operation performed by a user.

3. The receiving space in the knife sharpening support can receive spare sharpening rods and tapered rods. As long as the knife sharpening rods with different functions are replaced in the open groove, different purposes such as coarse sharpening and fine sharpening can be achieved, to meet various knife sharpening requirements, so that the knife sharpener can have a plurality of sharpening functions (for example, coarse sharpening, fine sharpening, and polishing).

4. The knife sharpening rod in the open groove of the knife sharpening support is rotatable such that different surfaces of the knife sharpening rod are configured to sharpen the knife, thereby improving usage efficiency of the knife sharpening rod.

5. The handle is detachably connected to the knife sharpening portion, has a hollow interior and is configured to receive the knife sharpening support, the knife sharpening rod thereof, and the like, which reduces the overall volume of the knife sharpener. The ability to store components of the knife sharpening portion makes it easy to carry, and protect, the knife sharpening support, the knife sharpening rod thereof, and the like.

6. The bottom portion of the handle includes a hand rope for case of carrying the knife sharpener. The end cap on the bottom portion of the handle includes a fourth hollowed-out portion that may be used to remove an arrowhead, which expands the usage of the disclosed device, enriching the overall use of the knife sharpener.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic structural diagram of an embodiment of angle gauge with an adjustable angle.

FIG. 2 is a second schematic structural diagram of the angle gauge depicted in FIG. 1.

FIG. 3 is a schematic structural diagram of a first support of the angle gauge depicted in FIG. 1.

FIG. 4 is a top view of the first support depicted in FIG. 3.

FIG. 5 is a schematic structural diagram of a first angle adjustment knob of the angle gauge depicted in FIG. 1.

FIG. 6 is a schematic structural diagram of a push tube of the angle gauge depicted in FIG. 1.

FIG. 7 is a top view of the push tube depicted in FIG. 6.

FIG. 8 is a schematic structural diagram of a first inclined surface-equipped member of the angle gauge depicted in FIG. 1.

FIG. 9 is a first cross-sectional view of the angle gauge depicted in FIG. 1 wherein the first inclined surface-equipped member is not raised.

FIG. 10 is a second cross-sectional view of the angle gauge depicted in FIG. 1 wherein the first inclined surface-equipped member is raised.

FIG. 11 is a schematic structural diagram of the first support of the angle gauge depicted in FIG. 1.

FIG. 12 is a schematic structural diagram of an embodiment of an angle gauge with an adjustable angle wherein a first inclined surface-equipped member is raised.

FIG. 13 is a second schematic structural diagram of the angle gauge depicted in FIG. 12 wherein the first inclined surface-equipped member is not raised.

FIG. 14 is a third schematic structural diagram of the angle gauge depicted in FIG. 12.

FIG. 15 is a fourth schematic structural diagram of the angle gauge depicted in FIG. 12.

FIG. 16 is a schematic structural diagram of an embodiment of an angle gauge with an adjustable angle.

FIG. 17 is a second schematic structural diagram of the angle gauge depicted in FIG. 16.

FIG. 18 is a schematic structural diagram of the first support of the angle gauge depicted in FIG. 16.

FIG. 19 is a top view of the first support depicted in FIG. 18.

FIG. 20 is a schematic structural diagram of the first angle adjustment knob of the angle gauge depicted in FIG. 16.

FIG. 21 is a schematic structural diagram of the push tube of the angle gauge depicted in FIG. 16.

FIG. 22 is a top view of a push tube depicted in FIG. 21.

FIG. 23 is a schematic structural diagram of the first inclined surface-equipped member of the angle gauge depicted in FIG. 16.

FIG. 24 is a first cross-sectional view of the angle gauge depicted in FIG. 16 wherein the first inclined surface-equipped member is not raised.

FIG. 25 is a second cross-sectional view of the angle gauge depicted in FIG. 16 wherein the first inclined surface-equipped member is raised.

FIG. 26 is a schematic structural diagram of the first support, the fourth elastic member, and four first inclined surface-equipped members of the angle gauge depicted in FIG. 16.

FIG. 27 is a first diagram of a mounting structure of an angle gauge depicted in FIG. 16 with a handle and a knife sharpening rod wherein the first inclined surface-equipped member is not raised.

FIG. 28 is a second diagram of a mounting structure of an angle gauge depicted in FIG. 16 with a handle and a knife sharpening rod wherein the first inclined surface-equipped member is raised.

FIG. 29 is a first three-dimensional view of an embodiment of a knife sharpener wherein the first inclined surface-equipped member is not raised.

FIG. 30 is a second three-dimensional view of the knife sharpener depicted in FIG. 29 wherein the first inclined surface-equipped member is raised.

FIG. 31 is a third three-dimensional view of the knife sharpener depicted in FIG. 29 wherein the first inclined surface-equipped member is raised.

FIG. 32 is a cross-sectional view of the knife sharpener depicted in FIG. 29.

FIG. 33 is a partially enlarged view of FIG. 32.

FIG. 34 is a top end view of the knife sharpening support portion of the knife sharpener depicted in FIG. 29.

FIG. 35 is a cross-sectional view taken along F-F in FIG. 34.

FIG. 36 is a first schematic structural diagram of the knife sharpening support portion of the knife sharpener depicted in FIG. 29.

FIG. 37 is a second schematic structural diagram of the knife sharpening support portion of the knife sharpener depicted in FIG. 29 wherein a third knob in the shape of a frustum is mounted to the knife sharpening support portion.

FIG. 38 is a third schematic structural diagram of the knife sharpening support portion of the knife sharpener depicted in FIG. 29 and displaying a reserved gap and first buffer portion disposed therein.

FIG. 39 is a fourth schematic structural diagram of the knife sharpening support portion of the knife sharpener depicted in FIG. 29 wherein the knife sharpening rod is not mounted to the knife sharpening support portion.

FIG. 40 is a fifth schematic structural diagram of the knife sharpening support portion of the knife sharpener depicted in FIG. 29 wherein the knife sharpening rod is not mounted to the knife sharpening support portion.

FIG. 41 is a state diagram of the components of the knife sharpening support portion of the knife sharpener depicted in FIG. 29 wherein the support structure is hidden.

FIG. 42 is a schematic structural diagram of the third connecting member of the knife sharpener depicted in FIG. 29.

FIG. 43 is a first schematic structural diagram of the handle of the knife sharpener depicted in FIG. 29 wherein the end cap is removed from the handle.

FIG. 44 is a second schematic structural diagram of the handle of the knife sharpener depicted in FIG. 29 wherein the end cap is removed from the handle.

FIG. 45 is a first schematic structural diagram of the end cap of the knife sharpener depicted in FIG. 29.

FIG. 46 is a second schematic structural diagram of the end cap of the knife sharpener depicted in FIG. 29.

FIG. 47 is a first three-dimensional view of the knife sharpener depicted in FIG. 29 with the knife sharpening support portion disposed within the handle.

FIG. 48 is a second three-dimensional view of the knife sharpener depicted in FIG. 29 with the knife sharpening support portion disposed within the handle.

FIG. 49 is a cross-sectional view of the knife sharpener depicted in FIG. 29 with the knife sharpening support portion disposed within the handle.

FIG. 50 is a partial enlarged view of the bottom of the knife sharpener depicted in FIG. 29 with the knife sharpening support portion disposed within the handle.

FIG. 51 is a schematic structural diagram of the knife sharpener depicted in FIG. 29 with a tapered rod mounted thereto.

FIG. 52 is a schematic structural diagram of the tapered rod depicted in FIG. 51.

FIG. 53 is a three-dimensional view of an embodiment of a knife sharpener.

FIG. 54 is a cross-sectional view of the knife sharpener depicted in FIG. 53.

FIG. 55 is a first schematic structural diagram of the angle gauge of the knife sharpener depicted in FIG. 53.

FIG. 56 is a second schematic structural diagram of the angle gauge of the knife sharpener depicted in FIG. 53.

FIG. 57 is a schematic structural diagram of the first support of the knife sharpener depicted in FIG. 53.

FIG. 58 is a first cross-sectional view of the angle gauge of the knife sharpener depicted in FIG. 53 wherein the first inclined surface-equipped member is not raised.

FIG. 59 is a second cross-sectional view of the angle gauge of the knife sharpener depicted in FIG. 53 wherein the first inclined surface-equipped member is raised.

FIG. 60 is a schematic structural diagram of the first knob of the knife sharpener depicted in FIG. 53.

FIG. 61 is a schematic diagram of the third connecting member mounted to the angle gauge of the knife sharpener depicted in FIG. 53.

FIG. 62 is a cross-sectional view of the third connecting member mounted to the angle gauge of the knife sharpener depicted in FIG. 53.

FIG. 63 is a first schematic structural diagram of the third connecting member of the knife sharpener depicted in FIG. 53.

FIG. 64 is a second schematic structural diagram of the third connecting member of the knife sharpener depicted in FIG. 53.

FIG. 65 is a third schematic structural diagram of the third connecting member of the knife sharpener depicted in FIG. 53.

FIG. 66 is a state diagram of the components of the knife sharpening support portion of the knife sharpener depicted in FIG. 53 wherein the support structure is hidden.

FIG. 67 is a first diagram of a mounting structure of an embodiment of an angle gauge with an adjustable angle, a handle, and a knife sharpening rod wherein the first inclined surface-equipped member is not raised.

FIG. 68 is a second diagram of a mounting structure of the angle gauge, handle, and knife sharpening rod depicted in FIG. 67 wherein the first inclined surface-equipped member is raised.

FIG. 69 is a schematic structural diagram of the embodiment of the angle gauge depicted in FIG. 67 wherein the first inclined surface-equipped member is not raised.

FIG. 70 is a second schematic structural diagram of the angle gauge depicted in FIG. 67 wherein the first inclined surface-equipped member is raised.

FIG. 71 is a schematic structural diagram of the first support of the angle gauge depicted in FIG. 67.

FIG. 72 is a top view of the first support depicted in FIG. 67.

FIG. 73 is a schematic structural diagram of the first angle adjustment knob of the angle gauge depicted in FIG. 67.

FIG. 74 is a schematic structural diagram of the push tube of the angle gauge depicted in FIG. 67.

FIG. 75 is a top view of a push tube depicted in FIG. 67.

FIG. 76 is a schematic structural diagram of the first inclined surface-equipped member of the angle gauge depicted in FIG. 67.

FIG. 77 is a first cross-sectional view of the angle gauge depicted in FIG. 67 wherein the first inclined surface-equipped member is not raised.

FIG. 78 is a second cross-sectional view of the angle gauge depicted in FIG. 67 wherein the first inclined surface-equipped member is raised.

FIG. 79 is a schematic structural diagram of the first support, the fourth elastic member, and two first inclined surface-equipped members of the angle gauge depicted in FIG. 67.

FIG. 80 is a cross-sectional view of the knife sharpener depicted in FIG. 67.

FIG. 81 is an exploded view of the components of the handle of the knife sharpener depicted in FIG. 67.

### DETAILED DESCRIPTION

The present disclosure is further described below in combination with specific implementations. It should be understood that the embodiments are only used to describe the present disclosure, but not to limit the scope of the present disclosure. In addition, it should be understood that, after reading the content taught in the present disclosure, a person skilled in the art may make various modifications or changes to the present disclosure, and these equivalent forms also fall within the scope defined by the appended claims of this application. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

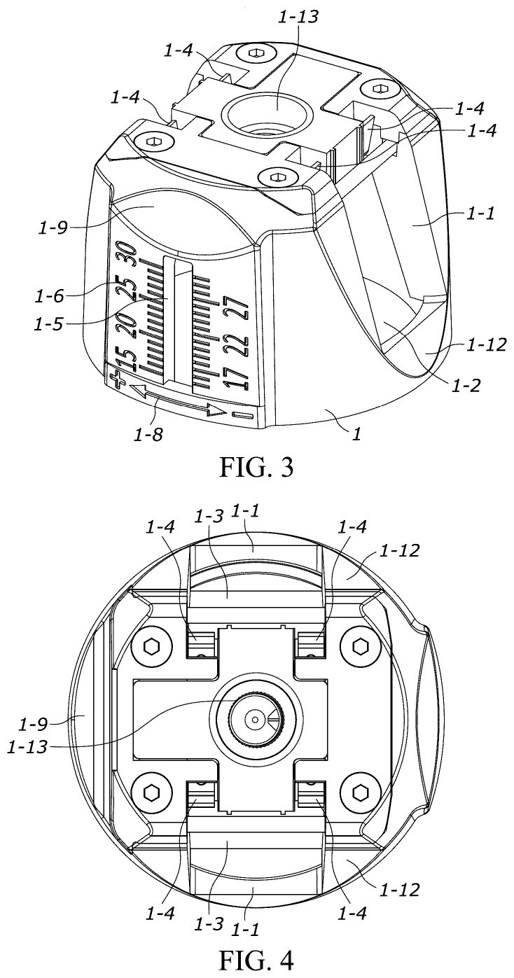

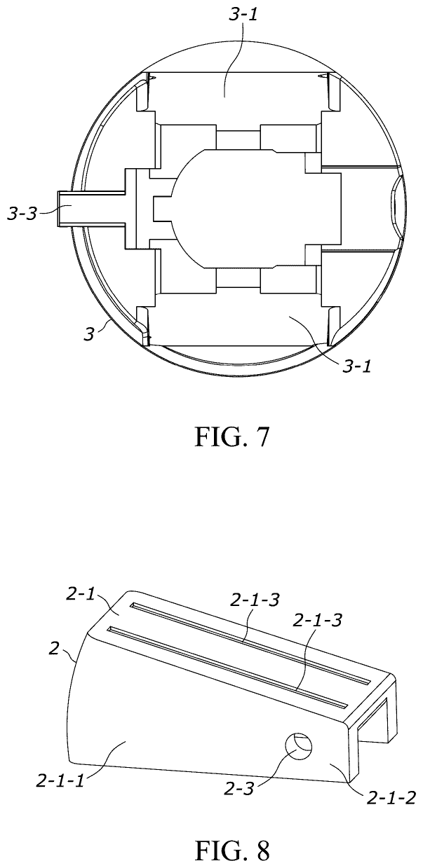

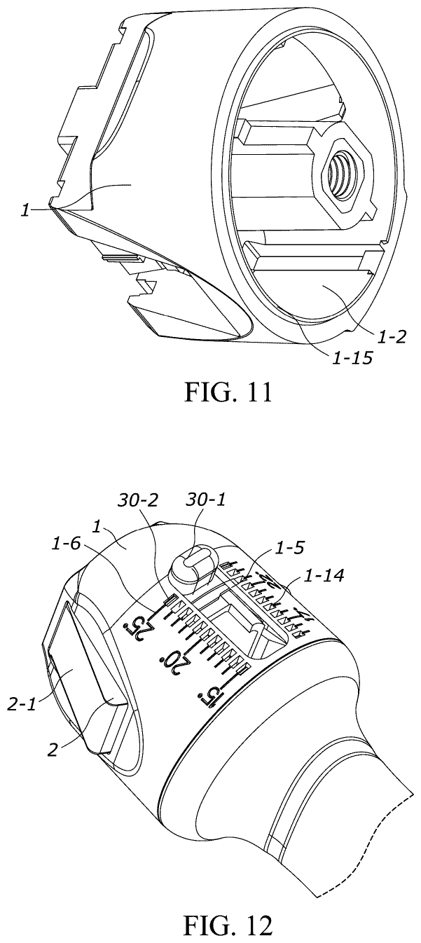

FIG. 1 to FIG. 11 depict an embodiment of an angle gauge with an adjustable angle. The angle gauge includes at least one set of angle adjustment mechanisms. Each set of angle adjustment mechanisms includes a first support 1, a first inclined surface-equipped member 2, a push tube 3 and a first angle adjustment knob 4. The first inclined surface-equipped member 2 is provided with a first inclined surface 2-1 for sharpening a knife. The “first inclined surface 2-1 for sharpening a knife” means that the first inclined surface 2-1 provides an initial angle for the knife, so that the knife is kept at an accurate angle on the knife sharpening rod 8-1 for sharpening, to improve a knife sharpening effect. The push tube 3 is provided with a second inclined surface 3-1.

The first inclined surface-equipped member 2 is rotatably connected to the first support 1. The rotatable connection is, for example, a connection by a shaft or a hinged connection, as long as an inclination angle of the first inclined surface 2-1 on the first inclined surface-equipped member 2 is changed or adjusted.

The first angle adjustment knob 4 and the push tube 3 are connected through threads to achieve axial movement of the push tube 3. The second inclined surface 3-1 drives a bottom portion of a higher end 2-1-1 of the first inclined surface on the first inclined surface-equipped member 2 to rise or fall, which can lift the higher end 2-1-1 of the first inclined surface more efficiently, adjust the inclination angle of the first inclined surface 2-1, and provide different initial angles for the knife during sharpening, thereby meeting angle requirements for the knife sharpening. The higher end 2-1-1 of the first inclined surface generally refers to an end of the first inclined surface 2-1 away from a knife sharpening portion (that is, a horizontal line where the knife sharpening rod 8-1 is located). A lower end 2-1-2 of the first inclined surface generally refers to an end of the first inclined surface 2-1 close to a knife sharpening portion (that is, a horizontal line where the knife sharpening rod 8-1 is located).

A joint of the first inclined surface-equipped member 2 and the first support 1 is close to the lower end 2-1-2 of the first inclined surface. In this way, it is ensured that the first inclined surface-equipped member 2 is rotatably connected to the first support 1, and the angle adjustment of the first inclined surface 2-1 is more efficient and convenient. In other words, based on a fact that the first inclined surface 2-1 has an original angle (for example, 15°, the original angle value may be adjusted based on an actual need), the push tube 3 moves in a forward direction (that is, the push tube 3 moves axially toward the first inclined surface-equipped member 2), so that the second inclined surface 3-1 lifts the bottom portion of the higher end 2-1-1 of the first inclined surface, to quickly increase the inclination angle of the first inclined surface 2-1 (for example, in a range of 15° to 30°, or the adjustment range of the inclination angle of the first inclined surface 2-1 may be expanded based on an actual need). When the push tube 3 moves in a reverse direction (that is, the push tube 3 moves axially away from the first inclined surface-equipped member 2), as the second inclined surface 3-1 gradually returns to the original position, the bottom portion of the higher end 2-1-1 of the first inclined surface gradually falls, and the angle of the first inclined surface 2-1 gradually returns to an original angle. In this way, the adjustment process of the inclination angle of the first inclined surface 2-1 is more convenient and efficient, thereby improving usage comfort. For example, the first inclined surface-equipped member 2 is a wedge or a wedge-like member.

The first support 1 is hollow inside. The hollow portion may be configured to be sleeved on the push tube 3, so that the push tube 3 can move axially inside the first support 1, thereby lifting the first inclined surface-equipped member 2 connected to a first mounting groove 1-1. The first support 1 is sleeved on the push tube 3 to limit the push tube 3 in a radial direction, to ensure that the threaded connection between the push tube 3 and the first angle adjustment knob 4 is more stable and is less likely to come loose. The first support 1 is provided with the first mounting groove 1-1, and the first inclined surface-equipped member 2 is connected to the first mounting groove 1-1 through a connecting shaft 1-3 (that is, a shaft mounting hole 2-3 of the first inclined surface-equipped member 2 is connected to the first support 1 through the connecting shaft 1-3, and a position where the shaft mounting hole is connected to the first support is also referred to as a joint of the first inclined surface-equipped member 2 and the first support 1). The first mounting groove 1-1 is in communication with inside and outside of the first support 1, to provide a space for flipping of the first inclined surface-equipped member 2, thereby achieving more reasonable use of an internal space of the first support 1. In addition, the first mounting groove 1-1 limits the first inclined surface-equipped member 2 and the first inclined surface 2-1 to positions corresponding to the knife sharpening portion or the knife sharpening rod 8-1, and finally realizes an adjustment effect of the inclination angle of the first inclined surface 2-1 and finally acts on the knife, thereby providing a precise knife sharpening angle for the knife sharpening.

In this embodiment, an outer side surface of the push tube 3 is provided with a first external thread 3-2, an end of the push tube 3 corresponding to the second inclined surface 3-1 is embedded in a first hollow portion 1-2 of the first support 1, and the second inclined surface 3-1 corresponds to the first inclined surface-equipped member 2; that is, the second inclined surface 3-1 faces the first inclined surface-equipped member 2. The inclination angle of the first inclined surface 2-1 on the first inclined surface-equipped member 2 is gradually adjusted through an inclination angle of the second inclined surface 3-1. The first angle adjustment knob 4 is hollow inside and has an inner wall provided with a first internal thread 4-2, the first angle adjustment knob 4 is sleeved on the push tube 3, and the first internal thread 4-2 matches the first external thread 3-2. A top portion of the first angle adjustment knob 4 abuts against a bottom portion of the first support 1. The top portion of the first angle adjustment knob 4 is limited by the first support 1, and the first angle adjustment knob 4 drives the push tube 3 to move axially through a threaded connection. For example, the bottom portion of the first support 1 is provided with a first boss portion 1-15, and the first boss portion 1-15 is embedded in an inner side wall of a top portion of the first angle adjustment knob 4, to achieve a limiting effect of the first support 1 and the first angle adjustment knob 4 in the radial direction.

The first support 1 is further provided with a hollowed-out first guide groove 1-5, the push tube 3 is further provided with a first protruding block 3-3, and the first protruding block 3-3 is embedded in the first guide groove 1-5. With the axial movement of the push tube 3, the first protruding block 3-3 moves synchronously in the first guide groove 1-5. An outer side wall of the first support 1 on each of two sides of the first guide groove 1-5 is further provided with a first identifier 1-6 for displaying an angle value. The inclination angle of the first inclined surface 2-1 may be infinitely adjusted or changed, and the first identifier 1-6 is mainly configured to identify a key angle value. In other words, the first protruding block 3-3 cooperates with the first identifier 1-6 to reflect a change in the inclination angle of the first inclined surface 2-1 in real time (for example, after the second inclined surface 3-1 of the push tube 3 lifts the first inclined surface-equipped member 2), which helps a user adjust the inclination angle of the first inclined surface 2-1 more precisely. In addition, the first guide groove 1-5 can limit the movement of the first protruding block 3-3, to ensure that the push tube 3 moves along an axial direction, and indirectly avoid circumferential rotation of the push tube 3, and the first guide groove 1-5 can further limit vertical movement of the first protruding block 3-3, thereby indirectly limiting an axial movement distance of the push tube 3; that is, axially limiting the push tube 3, and ensuring that the first external thread 3-2 and the first internal thread 4-2 between the push tube 3 and the first angle adjustment knob 4 are always connected, so that the two threads are not separated due to excessive rotation, which facilitates subsequent reuse of the first angle adjustment knob 4 and enables the push tube 3 to reciprocate axially. In this way, the angle gauge with an adjustable angle is always in a desirable operating state.

A second identifier 1-8 for indicating a rotation direction of the first angle adjustment knob 4 is arranged near the first guide groove 1-5; that is, indicating to the user a rotation direction of the first angle adjustment knob 4 corresponding to an increase in the inclination angle of the first inclined surface 2-1 and a rotation direction of the first angle adjustment knob 4 corresponding to a decrease in the inclination angle of the first inclined surface 2-1, thereby improving usage convenience, and improving usage comfort.

A first elastic member 1-4 (for example, a U-shaped elastic piece) configured to drive the first inclined surface-equipped member 2 to reset is further arranged between the first support 1 and the first inclined surface-equipped member 2. The first elastic member 1-4 and the push tube 3 are respectively located on two sides of the connecting shaft 1-3. When the push tube 3 moves axially toward the first inclined surface-equipped member 2 (that is, moves in the forward direction), the second inclined surface 3-1 gradually moves forward, and the bottom portion of the higher end of the first inclined surface 2-1-1 on the first inclined surface-equipped member 2 is gradually raised by the second inclined surface 3-1. In this case, the first inclined surface-equipped member 2 rotates with the connecting shaft 1-3 as a center, to increase the inclination angle of the first inclined surface 2-1. In addition, the bottom portion of the lower end 2-1-2 of the first inclined surface compresses the first elastic member 1-4 or further compresses the first elastic member 1-4. When the push tube 3 moves axially away from the first inclined surface-equipped member 2 (that is, moves in the reverse direction), the second inclined surface 3-1 gradually moves backward. In this case, the first elastic member 1-4 pushes the bottom portion of the lower end 2-1-2 of the first inclined surface, the first inclined surface-equipped member 2 rotates reversely with the connecting shaft 1-3 as the center, and the bottom portion of the higher end 2-1-1 of the first inclined surface is pressed downward, and gradually falls along the second inclined surface 3-1 until the first inclined surface is reset (that is, the bottom portion of the higher end of the first inclined surface-equipped member 2 slides to the bottom portion, and in this case, the inclination angle of the first inclined surface 2-1 is an original inclination angle thereof), to achieve effects of automatic resetting of the first inclined surface 2-1 and automatic retraction of the first inclined surface-equipped member 2 into the first mounting groove 1-1.

In this embodiment, the first inclined surface 2-1 faces away from the push tube 3, which helps the push tube 3 move axially to adjust the inclination angle of the first inclined surface 2-1. The first inclined surface 2-1 faces away from the first support 1, which is convenient to use the first inclined surface 2-1 to sharpen the knife. Generally, the lower end 2-1-2 of the first inclined surface faces the knife sharpening portion, which is convenient to use the first inclined surface 2-1 in cooperation with the knife sharpening portion to realize precise sharpening of a blade of the knife.

In this embodiment, the angle gauge with an adjustable angle meets sharpening requirements of different types of knives by adjusting the inclination angle of the first inclined surface 2-1, is applicable to the vast majority of knives, and greatly expands an application scope of the knife sharpening, without the need to replace an angle gauge with another fixed angle value as in the prior art, which saves costs and is more convenient and comfortable to use.

In addition, the inclination angle of the first inclined surface 2-1 may be infinitely adjusted in theory; for example, any angle in a range of 15° to 30° may be realized. Certainly, the angle range of 15° to 30° may also be adjusted based on an actual situation.

In this embodiment, two sets of angle adjustment mechanisms are used as an example. Two sets of first mounting grooves 1-1 and first inclined surface-equipped members 2, and one first guide groove 1-5 are respectively arranged on four sides of the first support 1. The two first inclined surface-equipped members 2 are opposite to each other in pairs and respectively correspond to open grooves 5-1 on a knife sharpening support 5 (that is, each first inclined surface-equipped member 2 corresponds to an open groove 5-1). The first guide groove 1-5 corresponds to a cowhide 8-2 for sharpening a knife.

A side of the first support 1 corresponding to the first mounting groove 1-1 is a fourth inclined surface 1-12. An inclination angle of the fourth inclined surface 1-12 is the same as the inclination angle of the first inclined surface 2-1. When the first inclined surface-equipped member 2 falls to a lowest position, that is, when the second inclined surface 3-1 leaves the bottom portion of the first inclined surface-equipped member 2, the inclination angle of the first inclined surface 2-1 is the angle of the first inclined surface-equipped member 2, that is, an unadjusted angle. In this case, the first inclined surface 2-1 and the fourth inclined surface 1-12 are flush with each other and on a same plane, so that the appearance is more aesthetic. The first inclined surface-equipped member 2 is also completely received in the first mounting groove 1-1. When the inclination angle of the first inclined surface 2-1 needs to be adjusted, an end of the first inclined surface-equipped member 2 is gradually raised, and the end of the first inclined surface-equipped member 2 gradually protrudes from the fourth inclined surface 1-12. In this case, the fourth inclined surface 1-12 does not cause any interference to the inclination angle of the first inclined surface 2-1 in front and rear directions. Based on an actual situation, the inclination angle of the fourth inclined surface 1-12 and the inclination angle of the first inclined surface 2-1 (that is, an angle of an included angle between the top portions of the first inclined surface-equipped members 2) may also be different.

A third inclined surface 1-9 is arranged at a position of the first support 1 corresponding to a top portion of the first guide groove 1-5. The third inclined surface 1-9 provides an initial angle for sharpening the knife on the cowhide 8-2. For example, an angle of the third inclined surface 1-9 is 20°, and the angle of the third inclined surface 1-9 is not adjustable.

In the angle gauge with an adjustable angle in this embodiment, the inclination angle of the first inclined surface 2-1 can be arbitrarily adjusted as long as the first angle adjustment knob 4 is rotated, to provide knife sharpening angles for various knives. The angle gauge may be connected to any part of the knife sharpening rod of the knife sharpener, to complete sharpening of various knives in cooperation with the knife sharpening rod. The application range is wide, and the initial angles provided by the angle gauge may be adjusted.

The angle gauge with an adjustable angle may be used separately. For example, the angle gauge is placed on a knife sharpening surface of a knife sharpening stone (a ceramic plate, a diamond plate, or another knife sharpening tool), and the tool provides an initial knife sharpening angle for the knife through an inclined surface (for example, the first inclined surface 2-1). The inclination angle of the first inclined surface 2-1 may also be adjusted based on an actual need.

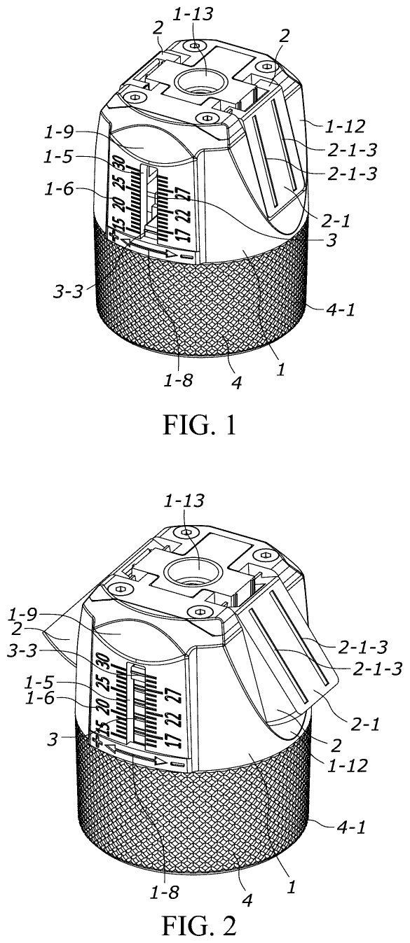

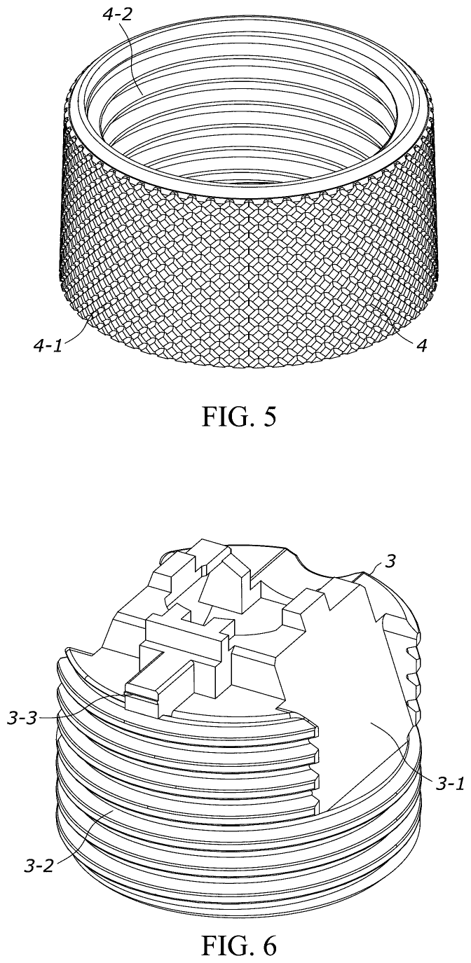

FIG. 1, FIG. 2, and FIG. 5 depict an angle gauge with an adjustable angle wherein an outer side surface of the first angle adjustment knob 4 is provided with a first anti-slip portion 4-1. The first anti-slip portion 4-1 is, for example, a mesh-shaped anti-slip pattern, which is more suitable for manual twisting. The first angle adjustment knob 4 may be made of metal with good texture.

The first inclined surface 2-1 of the first inclined surface-equipped member 2 is provided with a third guide portion 2-1-3, for example, a third guide portion 2-1-3 formed by two linear grooves. For example, when the first support 1 is fixed to a third connecting member 6 through a threaded connection, the third connecting member 6 is tightened, and the third guide portion 2-1-3 is aligned with two ends of the open groove 5-1 of the knife sharpening support 5 or an excircle of the knife sharpening rod 8-1, it indicates that the knife sharpening support 5 and the first support 1 are mounted in an accurate position and have been mounted in place.

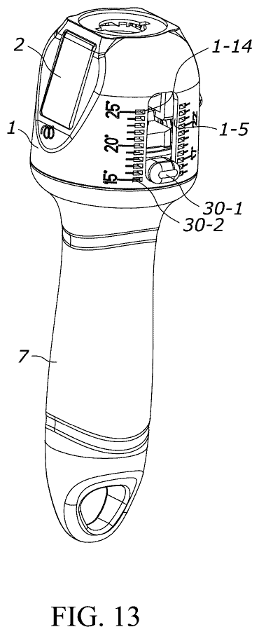

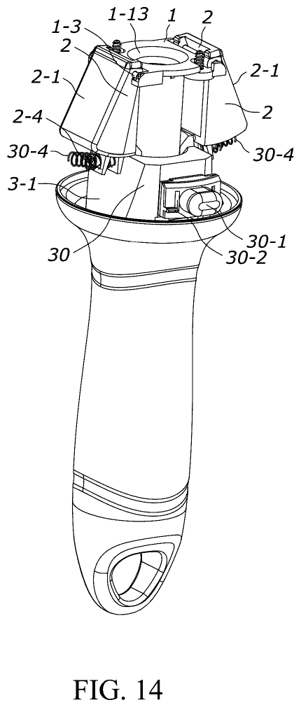

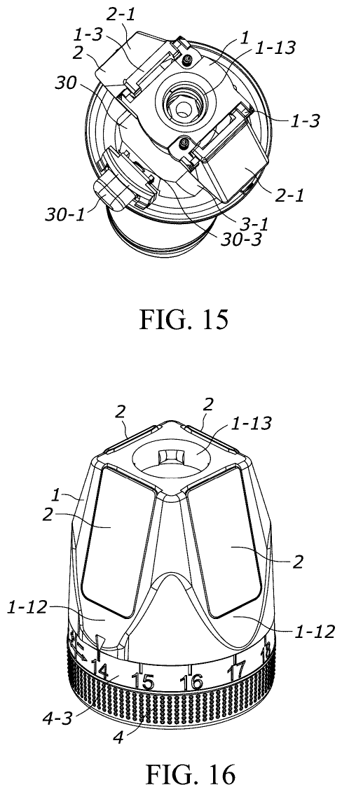

FIG. 12 to FIG. 15 depict an embodiment of an angle gauge with an adjustable angle. In this embodiment, the angle gauge includes a first support 1, a first inclined surface-equipped member 2, and an angle adjustment member. The first inclined surface-equipped member 2 is provided with a first inclined surface 2-1 for sharpening a knife. The angle adjustment member is provided with a second inclined surface 3-1. The first inclined surface-equipped member 2 is rotatably connected to the first support 1. Through movement of the angle adjustment member, the second inclined surface 3-1 drives a bottom portion of a higher end 2-1-1 of the first inclined surface-equipped member 2 to rise or fall, to adjust an inclination angle of the first inclined surface 2-1.

The first support 1 is provided with a plurality of first positioning grooves 1-14, the angle adjustment member is a push block 30, the push block 30 is provided with an elastic pressing portion 30-1, and the elastic pressing portion 30-1 is connected to a bump 30-2 (which is also referred to as a snap-fitting point). The bump 30-2 matches the corresponding first positioning groove 1-14 to achieve positioning of the push block 30 after the movement. A second elastic member 30-3 is arranged between the push block 30 and the elastic pressing portion 30-1, for example, a spring.

The first support 1 is further provided with a hollowed-out first guide groove 1-5, and the elastic pressing portion 30-1 is embedded in the first guide groove 1-5. When the clastic pressing portion 30-1 drives the push block 30 to move, the elastic pressing portion 30-1 synchronously moves along the first guide groove 1-5. In this case, the first guide groove 1-5 limits a movement trajectory of the clastic pressing portion 30-1.

With the movement of the push block 30, a first protruding block 3-3 moves synchronously in the first guide groove 1-5. An outer side wall of the first support 1 on one side or each of two sides of the first guide groove 1-5 is further provided with a first identifier 1-6 for displaying an angle value. The plurality of first positioning grooves 1-14 are arranged corresponding to the first identifiers 1-6. For example, the plurality of first positioning grooves 1-14 correspond to different angles of the first identifiers 1-6. When the bumps 302 are embedded in different first positioning grooves 1-14, the push block 30 also moves synchronously to different positions, to adjust the first inclined surface 2-1 to achieve different inclination angles. In this case, a position of the elastic pressing portion 30-1 also corresponds to a corresponding angle value of the first identifier 1-6. The elastic pressing portion 30-1 further plays the role of angle indication, so that the inclination angle of the first inclined surface 2-1 is visualized.

The angle gauge in this embodiment is used in the following manner. The elastic pressing portion 30-1 is pressed to enable the bump 30-2 to be separated from the first positioning groove 1-14 at the beginning, and the elastic pressing portion 30-1 is pushed to move, to drive the push block 30 to move (for example, move along an axial direction). After the second inclined surface 3-1 drives the bottom portion of the higher end 2-1-1 of the first inclined surface of the first inclined surface-equipped member 2 to rise or fall to a corresponding angle, that is, the inclination angle of the first inclined surface 2-1 is adjusted to a specified angle, the clastic pressing portion 30-1 is released. In this case, the bump 30-2 is embedded in the corresponding first positioning groove 1-14 to form a limiting structure, to achieve fixation of a position of the push block 30 (for example, fixation of a position in an axial direction), that is, the push block does not move, thereby ensuring that the inclination angle of the first inclined surface 2-1 remains unchanged.

The push block 30 may be in a shape of a push tube, or may be in another shape, as long as the push block 30 can move as the angle adjustment member. The second inclined surface 3-1 is used to drive the bottom portion of the higher end 2-1-1 of the first inclined surface on the first inclined surface-equipped member 2 to rise or fall, to adjust the inclination angle of the first inclined surface 2-1.

The first inclined surface-equipped member 2 is provided with an extension 2-4. The extension 2-4 is connected to an end of a third clastic member 30-4, and another end of the third clastic member 30-4 is connected to or abuts against an inner side wall of the first support 1. The third elastic member 30-4 helps the first inclined surface-equipped member 2 reset. When the inclination angle of the first inclined surface 2-1 is restored, the first inclined surface 2-1 automatically retracts until the first inclined surface is reset, without a need for an additional operation performed by a user.

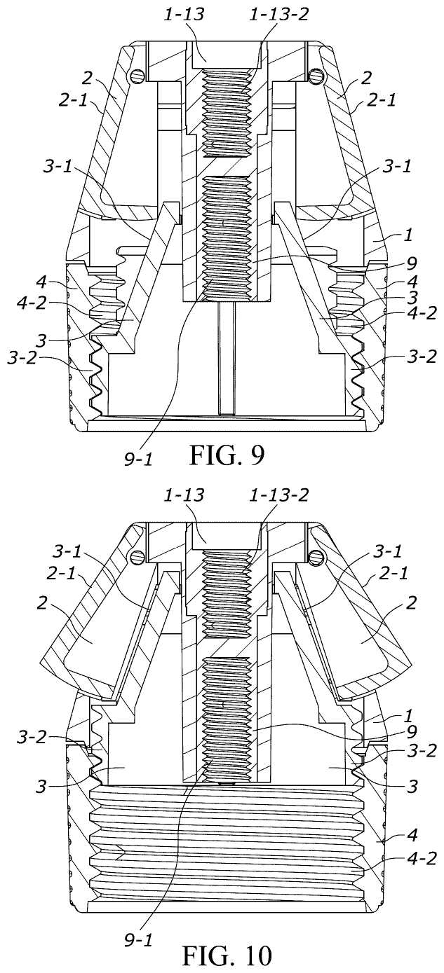

FIG. 9 to FIG. 10 depict an angle gauge with an adjustable angle wherein a top portion of a first support 1 is provided with a first connecting groove 1-13. The first connecting groove 1-13 is used for connecting a knife sharpening support 5 and/or a knife sharpening rod and/or a tapered rod.

The first connecting groove 1-13 is located on an axis of the first support 1. In this way, after the first support 1 is mounted to a knife sharpening portion (for example, the knife sharpening support 5), the first inclined surface 2-1 of the angle gauge corresponds to a knife sharpening rod 8-1 or a knife sharpening surface of the knife sharpening portion, which facilitates sharpening of a knife on the knife sharpening rod 8-1 by using the angle gauge.

Alternatively, a knife sharpening rod may be directly used for the knife sharpening portion. An end of the knife sharpening rod is connected and fixed to the first connecting groove 1-13. The first inclined surface 2-1 of the angle gauge corresponds to the knife sharpening rod, which facilitates the sharpening of a knife on the knife sharpening rod 8-1 by using the angle gauge.

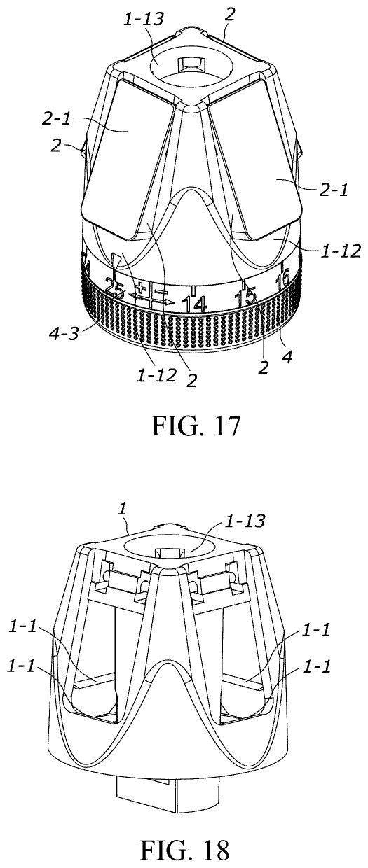

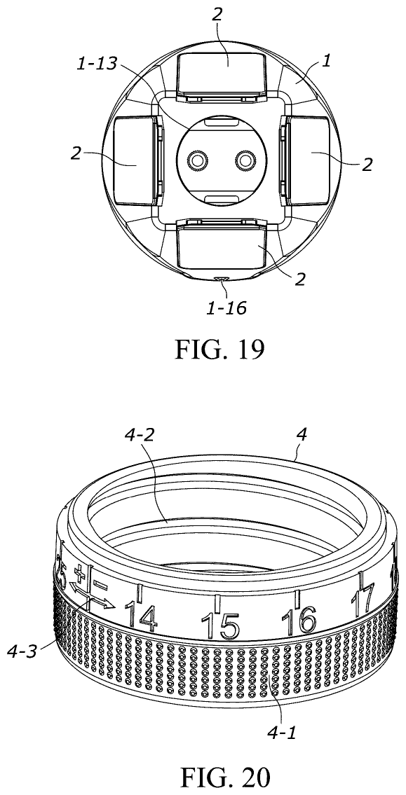

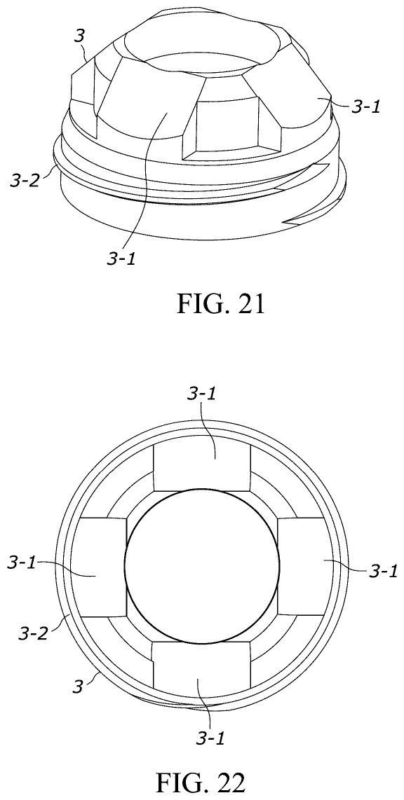

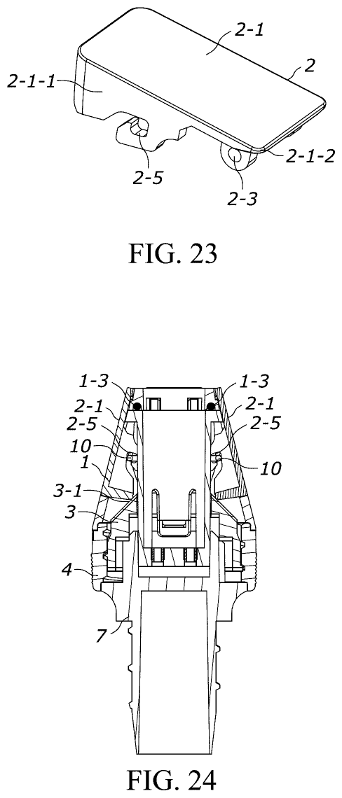

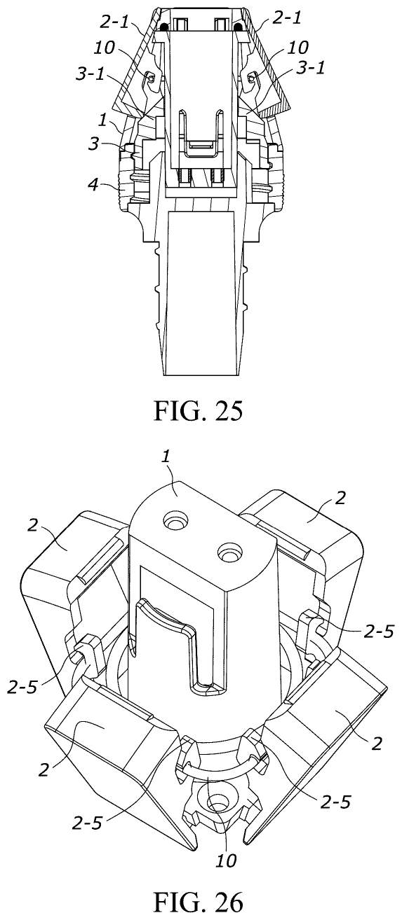

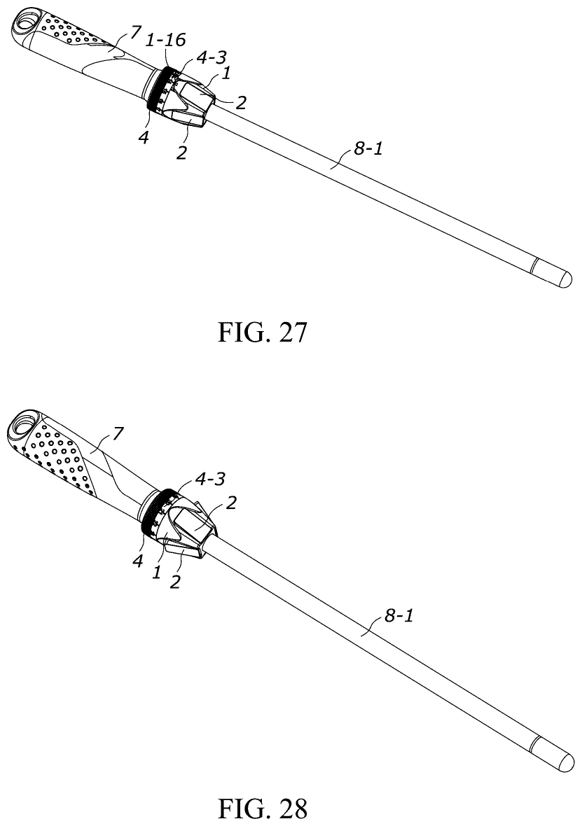

FIG. 16 to FIG. 28 depict an embodiment of an angle gauge with an adjustable angle. In this embodiment, a push tube 3 is provided with four second inclined surfaces 3-1. Each of the second inclined surfaces 3-1 corresponds to one first inclined surface-equipped member 2. Four first inclined surface-equipped members 2 are distributed on four sides of a first support 1, for example, on four sides of a top end of the first support 1 or in four directions, to more fully utilize the knife sharpening portion of the knife sharpening rod to sharpen the knife.

The four first inclined surface-equipped members 2 are all connected to a fourth elastic member 10 (for example, an O-shaped elastic ring). When the push tube moves in a reverse direction, the four first inclined surface-equipped members 2 are automatically reset synchronously under the action of the fourth elastic member 10, and the first inclined surface-equipped members 2 automatically retract into a first mounting groove 1-1. For example, a bottom portion of each first inclined surface-equipped member 2 is provided with a hook 2-6, and the same fourth elastic member 10 (for example, an O-shaped elastic ring) is hooked onto hooks 2-6 of the four first inclined surface-equipped members 2.

The first support 1 is provided with an indication portion 1-16. An outer side surface of a first angle adjustment knob 4 is provided with a third identifier 4-3. The indication portion 1-16 cooperates with the third identifier 4-3. The third identifier 4-3 includes an identifier of a rotation direction of the first angle adjustment knob 4 and/or an identifier of a rotation angle value of the first angle adjustment knob 4, which are configured to display the rotation direction and/or the rotation angle value of the first angle adjustment knob (4). A user may select the rotation direction of the first angle adjustment knob 4 based on the third identifier 4-3, to quickly adjust an inclination angle of a first inclined surface 2-1. Different angle values of the third identifier corresponding to the indication portion 1-16 help the user quickly determine a rotation amplitude of the first angle adjustment knob 4.

In an embodiment, the angle gauge may be further provided with three sets of angle adjustment mechanisms. Three first inclined surfaces 2-1 respectively correspond to different knife sharpening surfaces of two different knife sharpening rods or a same knife sharpening rod, or different knife sharpening surface positions on a knife sharpening plate (for example, a ceramic plate or a diamond plate).

Alternatively, the angle gauge may be further provided with five sets of angle adjustment mechanisms. Five first inclined surfaces 2-1 respectively correspond to different knife sharpening surfaces of two different knife sharpening rods or a same knife sharpening rod, or different knife sharpening surface positions on a knife sharpening plate.

Alternatively, the angle gauge may be further provided with six sets of angle adjustment mechanisms. Six first inclined surfaces 2-1 respectively correspond to different knife sharpening surfaces of two different knife sharpening rods or a same knife sharpening rod, or different knife sharpening surface positions on a knife sharpening plate.

Alternatively, the angle gauge may be further provided with eight sets of angle adjustment mechanisms. Eight first inclined surfaces 2-1 respectively correspond to different knife sharpening surfaces of two different knife sharpening rods or a same knife sharpening rod, or different knife sharpening surface positions on a knife sharpening plate.

In an embodiment, the angle gauge includes a set of angle adjustment mechanisms. The set of angle adjustment mechanisms includes a first support 1, a first inclined surface-equipped member 2, and an angle adjustment member. The first inclined surface-equipped member 2 is provided with a first inclined surface 2-1. The angle adjustment member is provided with a second inclined surface 3-1. The first inclined surface-equipped member 2 is rotatably connected to the first support 1. Through movement of the angle adjustment member, the second inclined surface 3-1 drives an end of the first inclined surface-equipped member 2 to rise or fall, to adjust an inclination angle of the first inclined surface 2-1. The first inclined surface 2-1 provides different initial angles for sharpening a knife on a knife sharpening rod.

Further, the second inclined surface 3-1 drives a bottom portion of a higher end 2-1-1 of the first inclined surface on the first inclined surface-equipped member 2 to rise or fall, to adjust the inclination angle of the first inclined surface 2-1.

A joint of the first inclined surface-equipped member 2 and the first support 1 is close to a lower end 2-1-2 of the first inclined surface.

The angle adjustment member moves from a higher position to a lower position of the first inclined surface 2-1, so that the bottom portion of the first inclined surface-equipped member 2 corresponding to the higher end 2-1-1 of the first inclined surface is gradually raised along the second inclined surface 3-1, and the inclination angle of the first inclined surface 2-1 gradually increases. The angle adjustment member moves from the lower position to the higher position of the first inclined surface 2-1, so that the bottom portion of the first inclined surface-equipped member 2 corresponding to the higher end 2-1-1 of the first inclined surface gradually falls along the second inclined surface 3-1, and the inclination angle of the first inclined surface 2-1 gradually decreases.

The first inclined surface-equipped member 2 and the angle adjustment member may be wedge-like members or wedges, or may be bodies in another shape provided with corresponding inclined surfaces that can achieve corresponding functions of two inclined surfaces.

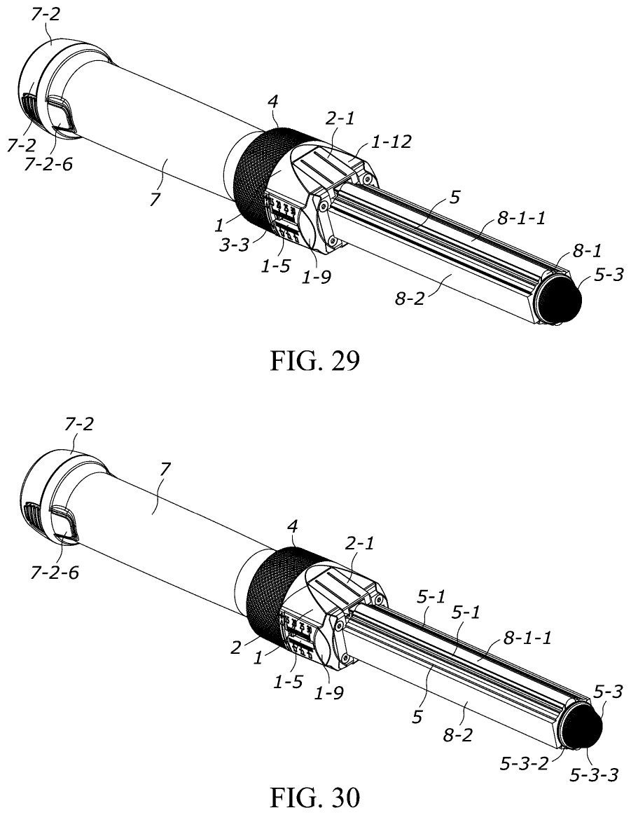

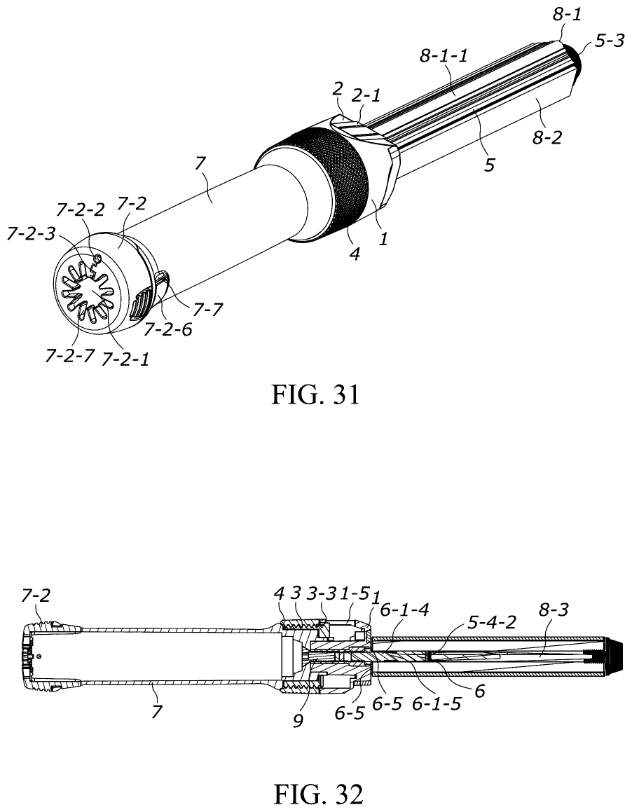

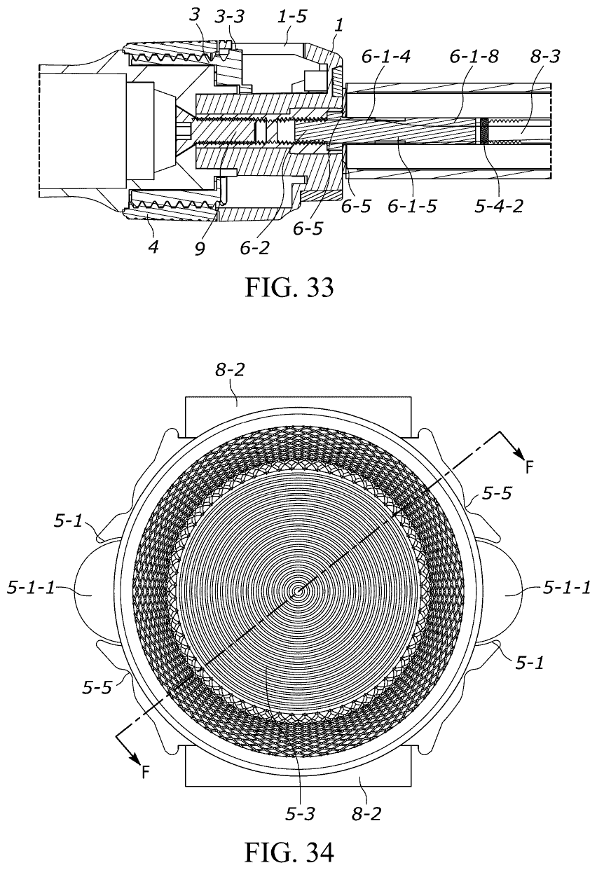

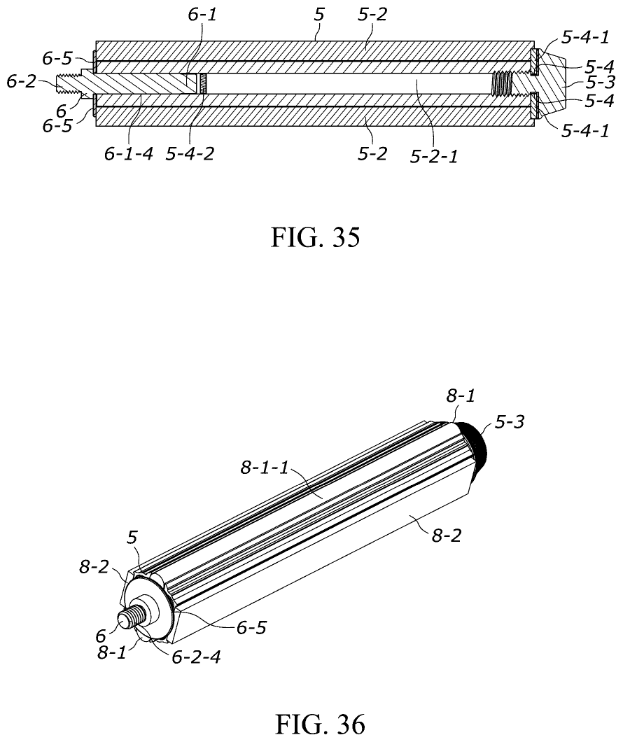

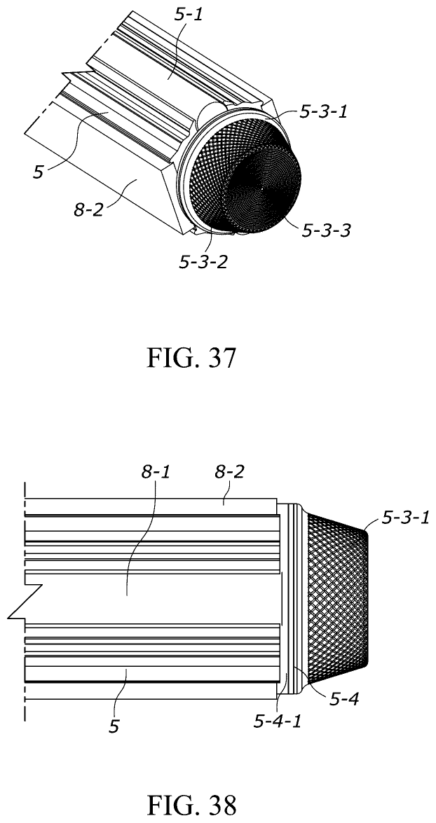

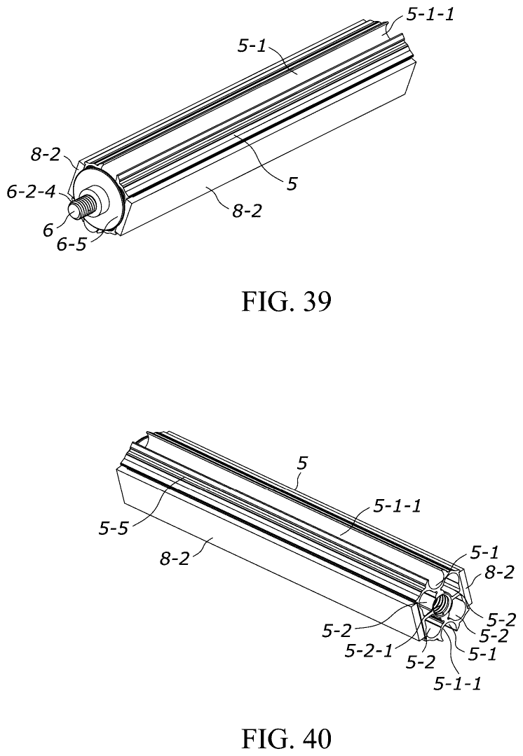

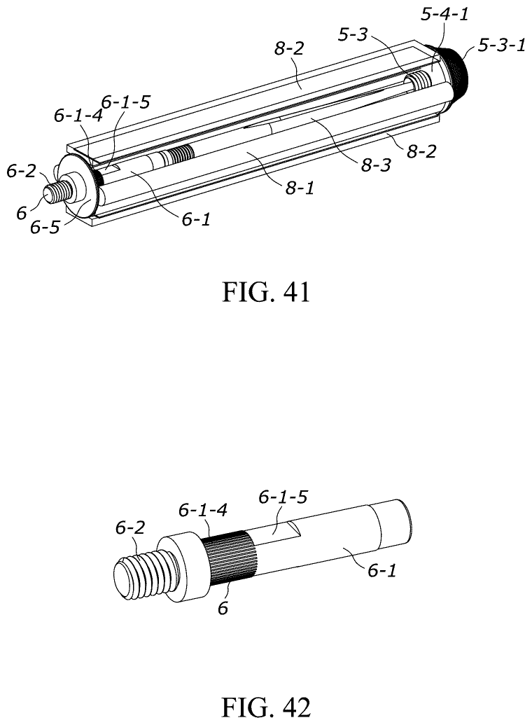

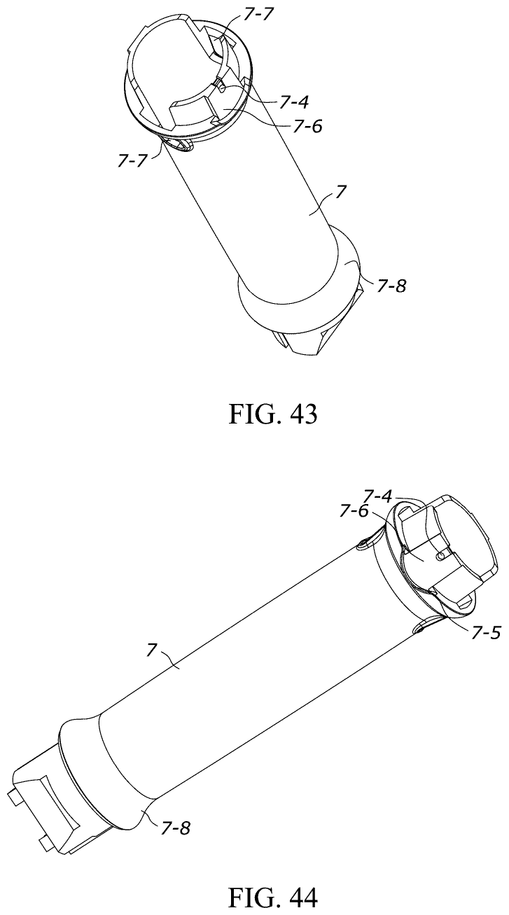

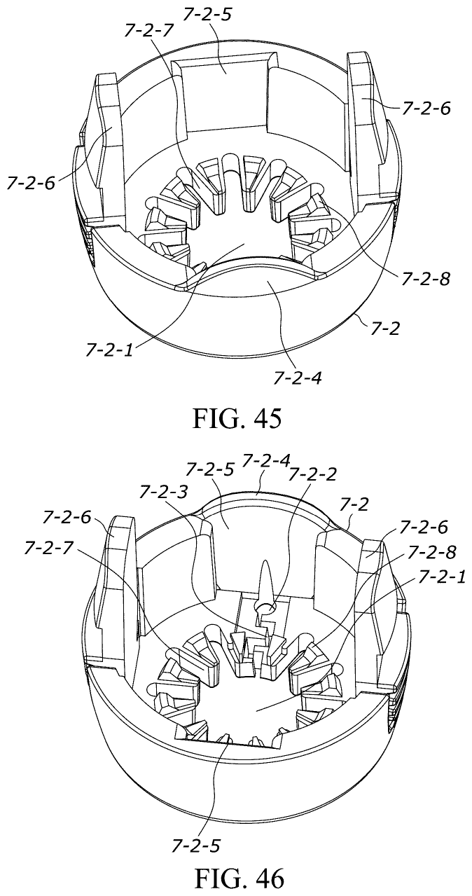

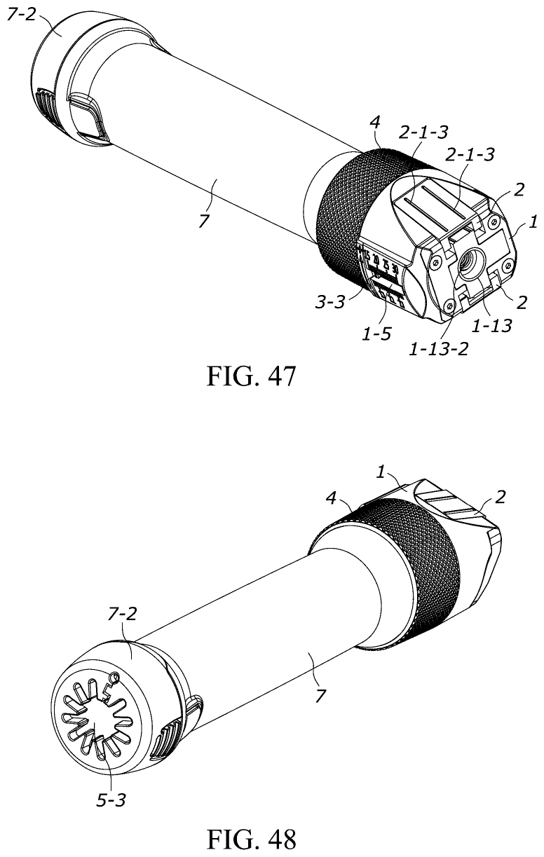

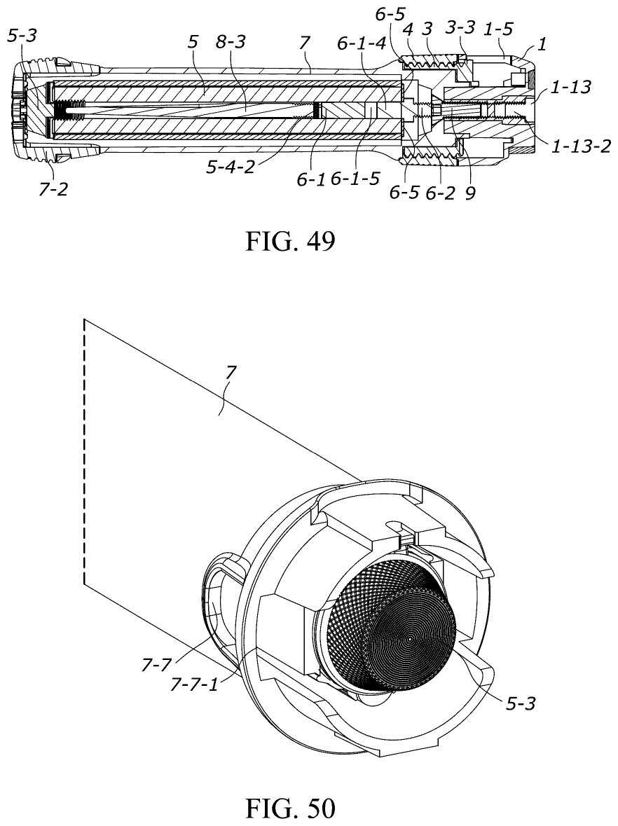

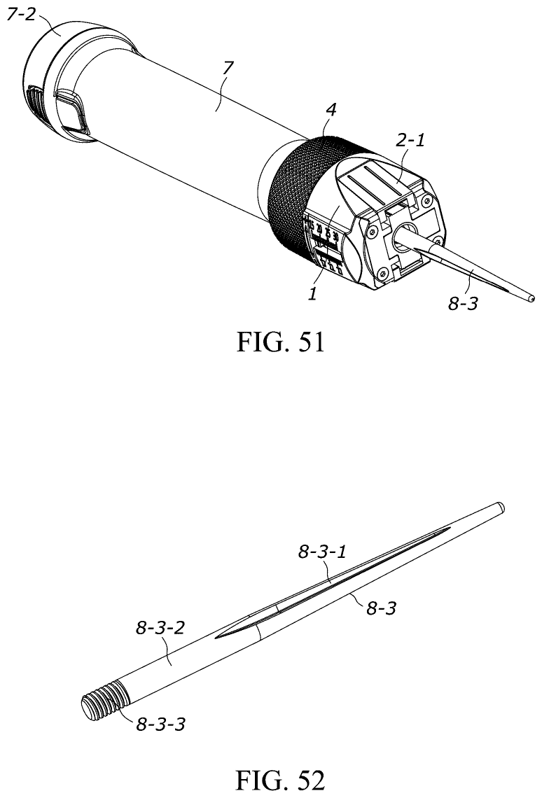

FIG. 29 to FIG. 52 depict an embodiment of a knife sharpener. The knife sharpener includes the angle gauge with an adjustable angle described in the above embodiments. A first support 1 is connected to a knife sharpening portion. A first inclined surface 2-1 provides a knife sharpening angle for a knife of the knife sharpening portion; that is, the first inclined surface 2-1 provides the knife sharpening angle for sharpening a knife on the knife sharpening portion. The knife sharpening portion includes a knife sharpening support 5 and a knife sharpening rod 8-1. A receiving space for receiving the knife sharpening rod 8-1 and/or a tapered rod 8-3 is arranged inside the knife sharpening support 5.

For example, a bottom end of the knife sharpening support 5 is connected to the first support 1 through the third connecting member 6. An injection molded member may be selected as the third connecting member 6. The third connecting member 6 is divided into a connecting section A 6-1 and a connecting section B 6-2. The connecting section A 6-1 is embedded in another end of a tapered rod receiving hole 5-2-1, to achieve the connection between the third connecting member 6 and the knife sharpening support 5. An outer side surface of the connecting section B 6-2 of the third connecting member 6 is provided with a fourth external thread 6-2-4 for connecting the first support 1. For example, a fourth internal thread 1-13-2 is arranged in the first connecting groove 1-13 (in this case, the fourth internal thread 1-13-2 may also be a third internal thread 9-1 of a threaded bushing insert 9, an end of the threaded bushing insert 9 extends to an opening portion of the first connecting groove 1-13, or the fourth internal thread 1-13-2 may also be an internal thread that is separately arranged). The fourth internal thread 1-13-2 matches the fourth external thread 6-2-4 to achieve the connection between the first support 1 and the third connecting member 6.

Preferably, a gasket 6-5, such as an annular gasket made of metal, configured to abut against the knife sharpening rod 8-1 in a receiving hole 5-2 is arranged at a joint of the connecting section A 6-1 and the connecting section B 6-2 of the third connecting member 6, to improve rigidity of the gasket.

The connecting section A 6-1 of the third connecting member 6 is in a shape of a round rod body. An outer side surface of the connecting section A 6-1 is provided with a knurled portion 6-1-4. After the connecting section A 6-1 is embedded in an other end of the tapered rod receiving hole 5-2-1, the knurled portion 6-1-4 is in an interference fit with the other end of the tapered rod receiving hole 5-2-1, to achieve the connection between the third connecting member 6 and the knife sharpening support 5. Preferably, the knurled portion 6-1-4 is located at a position on the connecting section A 6-1 close to the connecting section B 6-2. The connecting section A 6-1 is further provided with a third through hole 6-1-5, such as a third through hole 6-1-5 in a radial direction. Through the design of the knurled portion 6-1-4 and the third through hole 6-1-5, an assembly accuracy requirement for respectively aligning two ends of an open groove 5-1 on the knife sharpening support 5 with two third guide portions 2-1-3 on the first inclined surface 2-1 can be met, thereby improving an assembly speed and position accuracy of the third connecting member 6 with the first support 1 and the knife sharpening support 5.

Specific assembly steps are as follows. First, a part of the connecting section A 6-1 is embedded in the other end of the tapered rod receiving hole 5-2-1 (in this case, the connecting section A 6-1 and the tapered rod receiving hole 5-2-1 have been pre-riveted, but circumferential positions thereof may be adjusted), and the knurled portion 6-1-4 and the third through hole 6-1-5 are maintained outside the tapered rod receiving hole 5-2-1. Secondly, the third connecting member 6 and the knife sharpening support 5 are rotated together, so that the fourth external thread 6-2-4 is locked with the fourth internal thread 1-13-2. In addition, a latch (not shown in the figure) is inserted through the third through hole 6-1-5, and the latch is rotated to drive the third connecting member 6 and the knife sharpening support 5 to rotate together, to achieve locking between the fourth external thread 6-2-4 and the fourth internal thread 1-13-2 (that is, achieve the threaded connection between the first support 1 and the third connecting member 6). Thirdly, the first support 1 and the third connecting member 6 are kept stationary, and the knife sharpening support 5 sleeved on the connecting section A 6-1 is rotated circumferentially until the two ends of the open groove 5-1 on the knife sharpening support 5 are respectively aligned with the two third guide portions 2-1-3 on the first inclined surface 2-1. Then reverse rotation is performed through the latch. The third connecting member 6 and the knife sharpening support 5 are rotated together in a reverse direction until the fourth external thread 6-2-4 is separated from the fourth internal thread 1-13-2. The first support 1 and the third connecting member 6 are separated to facilitate the removal of the third connecting member 6 and the knife sharpening support 5 from the first support 1. In this process, no circumferential rotation occurs between the third connecting member 6 and the knife sharpening support 5. Finally, the latch is removed, and the removed knife sharpening support 5 and the connecting section A 6-1 are riveted; that is, the knurled portion 6-1-4 is riveted to the tapered rod receiving hole 5-2-1 to form an interference fit between the knurled portion 6-1-4 and the other end of the tapered rod receiving hole 5-2-1. The connecting section A 6-1 and the knife sharpening support 5 are fixed in both an axial direction and a circumferential direction. At this point, position calibration of the fourth external thread 6-2-4 and the open groove 5-1 on the knife sharpening support 5 in the circumferential direction is completed. Subsequently, a user only needs to lock the fourth external thread 6-2-4 and the fourth internal thread 1-13-2 to ensure that the two ends of the open groove 5-1 on the knife sharpening support 5 are respectively aligned with the two third guide portions 2-1-3 on the first inclined surface 2-1, so that the mounting between the knife sharpening support 5 and the first support 1 is efficient and highly precise.

A top end of the knife sharpening support 5 is provided with a third knob 5-3 for abutting against the knife sharpening rod 8-1 and/or the tapered rod 8-3 in the receiving space. For example, the third knob 5-3 is threadedly connected to the top end of the knife sharpening support 5 (for example, a top end of the tapered rod receiving hole 5-2-1). After the third knob 5-3 is removed, the knife sharpening rod 8-1 and/or the tapered rod 8-3 may be conveniently received in the receiving space (for example, the receiving hole 5-2), or the knife sharpening rod 8-1 and/or the tapered rod 8-3 may be conveniently taken from the receiving space. The third knob 5-3 may abut against the knife sharpening rod 8-1 and/or the tapered rod 8-3 in the receiving space to prevent the knife sharpening rod 8-1 and/or the tapered rod 8-3 from sliding out of the top end of the receiving hole 5-2. After the third connecting member 6 is embedded in the knife sharpening support 5, a top end of the connecting section A 6-1 can be further configured to abut against the tapered rod 8-3. Through the third knob 5-3, the tapered rod 8-3 is received and limited in the tapered rod receiving hole 5-2-1, and the tapered rod 8-3 is prevented from accidentally shaking.

Preferably, a third knob cap 5-3-1 of the third knob 5-3 is in a shape of a frustum, which may effectively prevent a knife from colliding with the third knob cap 5-3-1 during sharpening of a knife (for example, knife swinging) and protect the knife.

An outer side surface of the third knob cap 5-3-1 is provided with a third anti-slip portion 5-3-2. For example, the third anti-slip portion 5-3-2 is a mesh anti-slip pattern, which facilitates mounting and removal of the third knob 5-3.

A top end of the third knob cap 5-3-1 is provided with a fourth anti-slip portion 5-3-3, and the fourth anti-slip portion 5-3-3 includes a plurality of annular anti-slip patterns. When the entire angle gauge with an adjustable angle needs to be vertically placed, for example, the top end of the third knob cap 5-3-1 abuts against a tabletop (which may also be another fixed component, such as a wooden plate), the fourth anti-slip portion 5-3-3 plays an anti-slip role between the third knob cap 5-3-1 and the tabletop. The design of the plurality of concentric annular anti-slip patterns of the fourth anti-slip portion 5-3-3 may maintain the same frictional force at any horizontal angle, achieve the same anti-slip effect, and ensure safer usage.

A reserved gap 5-4 is provided between the third knob cap 5-3-1 of the third knob 5-3 and the top end of the knife sharpening support 5, and a first buffer portion 5-4-1, such as a silicone buffer pad, is arranged in the reserved gap 5-4, to prevent a collision between the knife sharpening rod 8-1 and the third knob cap 5-3-1 more effectively and avoid noise. In this embodiment, the reserved gap 5-4 is filled with the first buffer portion 5-4-1, so that the knife sharpening rod 8-1 is flush with the top end of the knife sharpening support 5, to eliminate a movement gap of the knife sharpening rod 8-1, avoid the collision between the knife sharpening rod 8-1 and the third knob cap 5-3-1, and avoid noise.

In addition, a second buffer portion 5-4-2, such as a silicone buffer pad, may be further arranged between the connecting section A 6-1 of the third connecting member 6 and the tapered rod 8-3, to avoid a collision between the tapered rod 8-3 and the third connecting member 6 more effectively and avoid noise.

The knife sharpening support 5 is provided with an open groove 5-1 for mounting the knife sharpening rod 8-1. A surface of the knife sharpening rod 8-1 corresponding to an opening portion 5-1-1 of the open groove 5-1 is a knife sharpening surface 8-1-1. The knife is sharpened on the knife sharpening surface 8-1-1, and the knife sharpening rod 8-1 located in the open groove 5-1 may further rotate by itself, so that different positions on an outer surface of the knife sharpening rod 8-1 each have an opportunity to correspond to the opening portion 5-1-1 of the open groove 5-1, and can be configured to sharpen the knife, to maximize utilization of the outer surface of the knife sharpening rod 8-1, fully ensure operating efficiency of the knife sharpening rod 8-1, effectively increase a utilization rate of a rod body of the knife sharpening rod 8-1, and ensure that the knife sharpening rod 8-1 provides more and best knife sharpening effects for sharpening of a knife.

An arc length of a cross-section of the opening portion 5-1-1 is less than or equal to half of a circumference of a circle where a cross-section of the open groove 5-1 is located, which not only can ensure that the knife sharpening rod 8-1 is mounted in the opening portion 5-1-1 and is not easy to fall off, but also can maximize an area of the opening portion 5-1-1 (that is, an area of the knife sharpening surface 8-1-1) as large as possible, to provide convenience for sharpening the knife on the knife sharpening surface 8-1-1, and prevent an edge portion of the open groove 5-1 from affecting the sharpening of the knife.

An outer side surface of the knife sharpening support 5 is further provided with cowhides 8-2 for sharpening a knife, such as 2 yellow cowhides 8-2, which each have a polished surface and a rough surface, to increase usage scenarios of the knife sharpener, and not only may be used for sharpening the knife, but also may be used for polishing the knife.

In this embodiment, a cross-section of the knife sharpening support 5 is in a shape of a hexagon. The cowhides 8-2 (for example, an upper side surface and a lower side surface) are respectively arranged on two opposite sides in pairs, and the open groove 5-1 is provided at each of two corners (for example, a left end and a right end) away from the cowhides 8-2. The receiving space inside the knife sharpening support 5 is five receiving holes 5-2. For example, two receiving holes 5-2 each receive a spare diamond round tube knife sharpening rod 8-1, and the other two receiving holes 5-2 each receive a spare alumina polishing ceramic rod. The diamond round tube knife sharpening rod 8-1 and the alumina polishing ceramic rod may be both mounted in the open grooves 5-1, to achieve a corresponding knife sharpening function. The receiving hole 5-2 located in a middle part of the cross-section of the knife sharpening support 5 is the tapered rod receiving hole 5-2-1. An end of the tapered rod receiving hole 5-2-1 is connected to the third knob 5-3 (for example, an inner side wall of an end of the tapered rod receiving hole 5-2-1 corresponding to the third knob 5-3 is provided with an internal thread matching an external thread of the third knob 5-3). The other end of the tapered rod receiving hole 5-2-1 is connected to the third connecting member 6.

The receiving space is, for example, a plurality of receiving holes 5-2, which are used for receiving separately without interfering with each other, to avoid causing damage as a result of a collision with each other. The third knob 5-3 and the third connecting member 6 are respectively located at two ends of the knife sharpening support 5. In this case, the two ends of the receiving holes 5-2 corresponding to the knife sharpening support 5 are openings. Therefore, the third knob 5-3 and the third connecting member 6 respectively abut against two ends of the knife sharpening rod 8-1 and/or the tapered rod 8-3 inside the receiving holes 5-2.

The first support 1 is connected to an end of a handle 7. For example, an end (for example, a top end) of the first connecting groove 1-13 of the first support 1 is connected to the third connecting member 6, and another end (for example, a bottom end) of the first connecting groove 1-13 is connected to the threaded bushing insert 9. The threaded bushing insert 9 is connected to the end (for example, a top end) of the handle 7 through a bolt. In this case, a top portion of the handle 7 limits a bottom portion of the first angle adjustment knob 4, and limits a top portion of the first angle adjustment knob 4 in cooperation with the first support 1. When the first angle adjustment knob 4 rotates, the first angle adjustment knob 4 does not move in the axial direction, which ensures precision of axial movement of the push tube 3 when the first angle adjustment knob 4 rotates.

The top portion of the first angle adjustment knob 4 abuts against a bottom portion of the first support 1, which may prevent the first angle adjustment knob 4 from shaking, and reduce a shaking gap between the first angle adjustment knob 4 and the push tube 3, so that the axial movement of the push tube 3 is always coaxial with a center or an axis of the handle. The top portion of the first angle adjustment knob 4 is limited by the first support 1, and the bottom portion of the first angle adjustment knob 4 abuts against the handle 7. The bottom portion of the first angle adjustment knob 4 is limited by the handle 7. When the first angle adjustment knob 4 rotates, the first angle adjustment knob 4 does not moves in the axial direction. Correspondingly, the first angle adjustment knob 4 drives the push tube 3 to achieve axial movement through a threaded connection.

The top portion of the handle 7 (or a fourth boss portion 7-8 of the handle) may be further configured to abut against the push tube 3, to facilitate limiting of the push tube 3 in the axial direction. In other words, the bottom portion of the push tube 3 is axially limited by the handle 7, to avoid damage to a first protruding block 3-3 as a result of forcible and excessive rotation of the first angle adjustment knob 4 by a user.

The handle 7 is hollow inside and forms a fourth receiving space 7-1 for receiving the knife sharpening portion. When knife sharpening is not needed, the knife sharpening support 5 may be removed from the first support 1, and then the knife sharpening portion (that is, the knife sharpening support 5 and the knife sharpening rod 8-1, the tapered rod 8-3, the cowhide 8-2, and the like thereon) is received in the fourth receiving space 7-1 inside the handle 7, which reduces an overall volume of the knife sharpener, achieves a more aesthetic appearance, facilitates receiving of the overall knife sharpener (for example, received in a toolbox or a pocket of the user), and can further avoid accidental loss of the knife sharpening portion and avoid damage to the knife sharpening portion (especially the knife sharpening rod 8-1, the tapered rod 8-3, and the cowhide 8-2) as a result of an external reason such as an accidental collision.

An other end of the handle 7 is connected to an end cap 7-2. The end cap 7-2 cooperates with the handle 7 to realize receiving of the knife sharpening portion. The end cap 7-2 is provided with a plurality of arrow twisting teeth 7-2-7, and the arrow twisting teeth 7-2-7 form a fourth hollowed-out portion 7-2-1 for twisting an arrowhead. When the end cap 7-2 is tightened on the handle 7, the fourth hollowed-out portion 7-2-1 is configured to twist and remove an arrowhead from an arrow shaft. The arrow twisting teeth 7-2-7 facilitate disassembly and/or mounting of an arrowhead to an arrow shaft and allow a user to reuse the arrowhead and the arrow shaft, thereby increasing utilization rates of the arrowhead and the arrow shaft.

Preferably, a side of each of the arrow twisting teeth 7-2-7 facing inside of the handle 7 is provided with a fourth protrusion 7-2-8, which may prevent the knife sharpening support 5 from shaking when the knife sharpening support is received in the handle 7 and avoid noise.

The other end of the handle 7 is provided with a fourth mounting hole 7-4 for mounting a hand rope (not shown in the figure). The hand rope is mounted to the handle 7, which helps carry the knife sharpener, prevents loss of the knife sharpener, and avoids damage to the knife sharpener as a result of accidental falls. A fifth mounting hole 7-2-2 is provided at a position of the end cap 7-2 corresponding to the fourth mounting hole 7-4. The hand rope is tied to the fourth mounting hole 7-4 and runs through the fifth mounting hole 7-2-2 and then is placed outside the handle 7, to facilitate use of the hand rope. The fifth mounting hole 7-2-2 is in communication with the fourth hollowed-out portion 7-2-1 through a zigzag channel 7-2-3. An end of the hand rope is first connected to the fourth mounting hole 7-4, and then the other end of the hand rope runs through the fourth hollowed-out portion 7-2-1 and then is placed outside the handle 7. In this way, the mounting is more convenient and efficient. Then a rope body of the hand rope is pushed into the fifth mounting hole 7-2-2 along the zigzag channel 7-2-3. The zigzag channel 7-2-3 can limit the rope body of the hand rope in the fifth mounting hole 7-2-2, to prevent the rope body of the hand rope from easily returning to the fourth hollowed-out portion 7-2-1, and prevent the rope body of the hand rope from being cut by an arrowhead in the fourth hollowed-out portion 7-2-1. For example, when a user twists the arrowhead by using the fourth hollowed-out portion 7-2-1 of the end cap 7-2, the arrowhead is embedded in the fourth hollowed-out portion 7-2-1. If the rope body of the hand rope is in the fourth hollowed-out portion 7-2-1, the arrowhead is bound to cut the rope body of the hand rope.

The end cap 7-2 is provided with a fourth snap 7-2-6, and the other end of the handle 7 is provided with a fourth perforation 7-7. The fourth snap 7-2-6 matches the fourth perforation 7-7 to achieve a detachable connection between the handle 7 and the end cap 7-2. The user presses the fourth snap 7-2-6 through the fourth perforation 7-7, so that the fourth snap 7-2-6 is separated from the fourth perforation 7-7, which helps separate the end cap 7-2 from the handle 7. For example, the end cap 7-2 is provided with two fourth snaps 7-2-6, and the other end of the handle 7 is provided with two fourth perforations 7-7. The fourth snaps 7-2-6 and the fourth perforations 7-7 are arranged in pairs on two sides of the end cap 7-2, to facilitate usage. The handle 7 and the end cap 7-2 are securely connected.

The end cap 7-2 is provided with a second protruding positioning block 7-2-4, such as an arc-shaped convex block. The other end of the handle 7 is provided with a second positioning groove 7-5, such as an arc-shaped groove. The second protruding positioning block 7-2-4 matches the second positioning groove 7-5. Before the end cap 7-2 and the handle 7 are mounted, the second protruding positioning block 7-2-4 is aligned with the second positioning groove 7-5, so as to pre-determine mounting angles of the handle 7 and the end cap 7-2, implement a function of pre-positioning the handle 7 and the end cap 7-2, prevent incorrect mounting of the handle 7 and the end cap 7-2 (that is, the handle 7 and the end cap 7-2 are not aligned, and the end cap 7-2 and the handle 7 cannot be mounted), and prevent the rope body of the hand rope from being easily cut by the arrowhead as a result of misalignment of the fourth mounting hole 7-4 and the fifth mounting hole 7-2-2 after the handle 7 and the end cap 7-2 are mounted. In addition, after the end cap 7-2 and the handle 7 are mounted correctly, the second protruding positioning block 7-2-4 and the second positioning groove 7-5 are clamped together, which can also prevent the end cap 7-2 and the handle 7 from rotating axially.

The other end (that is, an outer side surface close to a bottom end) of the handle 7 is provided with a second limiting block 7-6. An inner side wall of the end cap 7-2 is provided with a second limiting groove 7-2-5. The second limiting block 7-6 matches the second limiting groove 7-2-5. After the handle 7 and the end cap 7-2 are aligned and mounted, the second limiting block 7-6 is also synchronously embedded in the second limiting groove 7-2-5, which can effectively prevent the end cap 7-2 and the handle 7 from rotating axially.

The knife sharpener further includes the knife sharpening portion. The knife sharpening portion further includes the tapered rod 8-3. The tapered rod 8-3 is provided with a hook sharpening groove 8-3-1 for sharpening a fishhook. An extended section 8-3-2 exists between a thicker end of the tapered rod 8-3 and the hook sharpening groove 8-3-1. After the tapered rod 8-3 is connected to the first support 1, a part of the extended section 8-3-2 is located outside the first support 1. During the fishhook sharpening, the hook sharpening groove 8-3-1 is caused to be not excessively close to the first support 1. Because once the fishhook is pushed by the first support 1, the fishhook cannot be sharpened, and an operating part of the tapered rod 8-3 (for example, a part configured to sharpen a knife) is also extended forward synchronously through the extended section 8-3-2, which is convenient for the tapered rod 8-3 to sharpen the fishhook more effectively.

The thicker end of the tapered rod 8-3 is provided with a third external thread 8-3-3, and the third external thread 8-3-3 matches a third internal thread 9-1 of the threaded bushing insert 9 or matches the fourth internal thread 1-13-2 in the first connecting groove 1-13, to achieve the connection between the tapered rod 8-3 and the first support 1 and facilitate the disassembly and assembly of the tapered rod 8-3 and the first support 1.

An inner side wall of the handle 7 is further provided with a reinforcing rib 7-9. An outer side wall of the knife sharpening support 5 is provided with a third positioning recess 5-5. The reinforcing rib 7-9 matches the third positioning recess 5-5. The reinforcing rib 7-9 increases strength of the handle 7, and the reinforcing rib 7-9 is aligned with the third positioning recess 5-5 before the knife sharpening support 5 is received inside the handle, so that the knife sharpening support 5 can be inserted into the handle 7 (that is, the fourth receiving space 7-1). After the knife sharpening support 5 is inserted into the handle 7, the reinforcing rib 7-9 abuts against the third positioning recess 5-5. For example, six sets of reinforcing ribs 7-9 and the third positioning recess 5-5 can relatively fix the position of the knife sharpening support 5 in the handle 7, so that the knife sharpening support 5 in the handle 7 does not accidentally shake. In addition, a gap is maintained between the knife sharpening support 5 and the inner side wall of the handle 7 to avoid friction or collision between the inner side wall of the handle 7 and the knife sharpening support 5 (especially the cowhide 8-2 and the knife sharpening rod 8-1 in the open groove 5-1), thereby protecting the cowhide 8-2 and the knife sharpening rod 8-1 in the open groove 5-1 from damage. In addition, the third positioning recess 5-5 can further prevent the knife from colliding with the knife sharpening support 5 during sharpening of the knife.

The knife sharpening rod 8-1 may be a hollow rod, which helps reduce an overall weight of the knife sharpener and facilitates carrying.

Specific use of the knife sharpener in this embodiment is as follows. The end cap 7-2 is opened, the knife sharpening support 5 in the handle 7 is taken out, an appropriate knife sharpening rod 8-1 may be selected and mounted in the open groove 5-1, the remaining knife sharpening rods 8-1 and the tapered rod 8-3 are received in the knife sharpening support 5, and then the knife sharpening support 5 is aligned with and connected to the first support 1 (the first support 1 has been mounted to the top end of the handle 7). Through rotation of the first angle adjustment knob 4, the first inclined surface 2-1 of the angle gauge is raised to an appropriate inclination angle, and then the knife is sharpened on the knife sharpening rod 8-1 by using the first inclined surface 2-1. Alternatively, the knife may be polished by using the cowhide 8-2 alone. When the tapered rod 8-3 needs to be used, the knife sharpening support 5 is removed from the first support 1, the third knob 5-3 is unscrewed from the top end of the knife sharpening support 5, the tapered rod 8-3 is taken out from the tapered rod receiving hole 5-2-1, and a hook or the knife may be sharpened by using the tapered rod 8-3 after the tapered rod 8-3 is mounted to the first support 1. When the arrowhead needs to be twisted, the handle 7 from which the knife sharpening support 5 has been removed is connected to the end cap 7-2, the arrow twisting teeth 7-2-7 on the end cap 7-2 are embedded in the arrowhead, and the handle 7 is rotated to drive the arrowhead to rotate, thereby realizing the disassembly and assembly of the arrowhead and the arrow. When the knife sharpener is not needed, the knife sharpener can be carried around after the knife sharpening support 5 (including the knife sharpening rod 8-1 and the tapered rod 8-3) is received inside the handle 7 and the end cap 7-2 is covered.

An inner side wall 7-7-1 of a bottom portion of the handle corresponding to the fourth perforation 7-7 is an arc surface, which may reduce an amount of engagement between the end cap 7-2 (which is actually the fourth snap 7-2-6) and the handle 7, and facilitate the removal of the end cap 7-2.

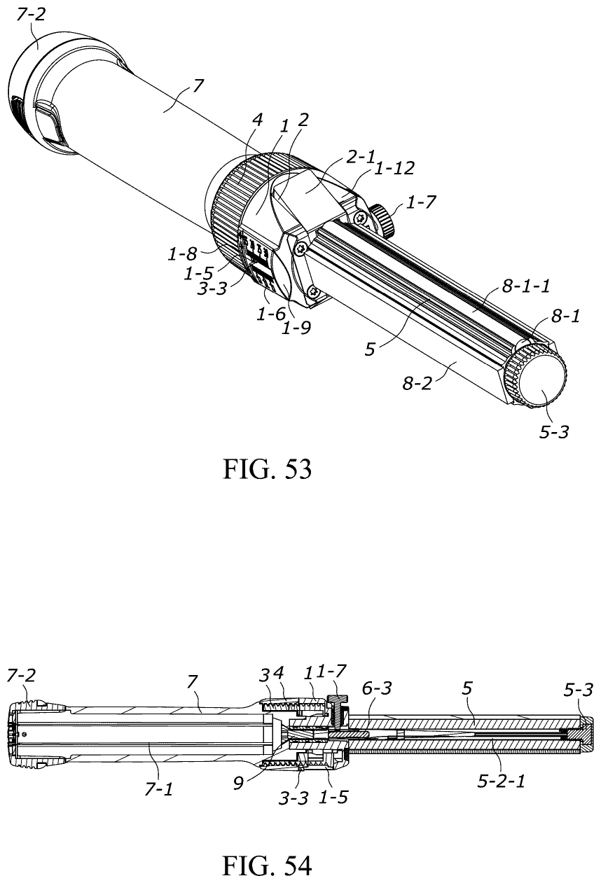

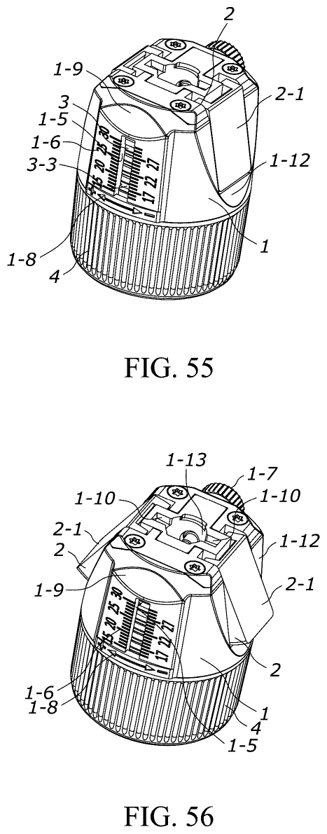

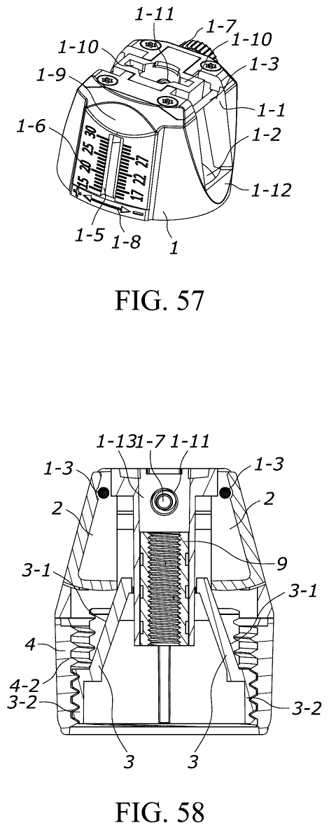

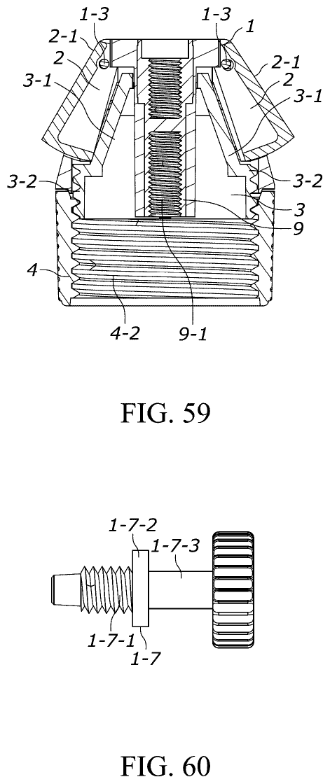

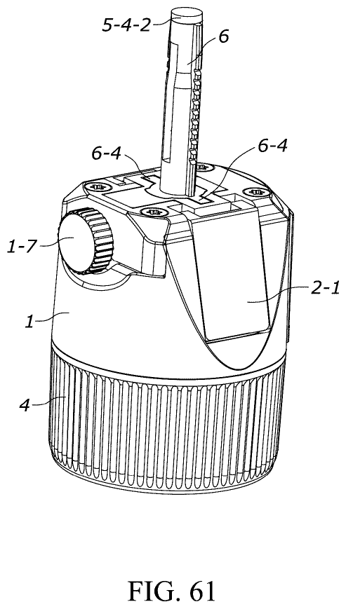

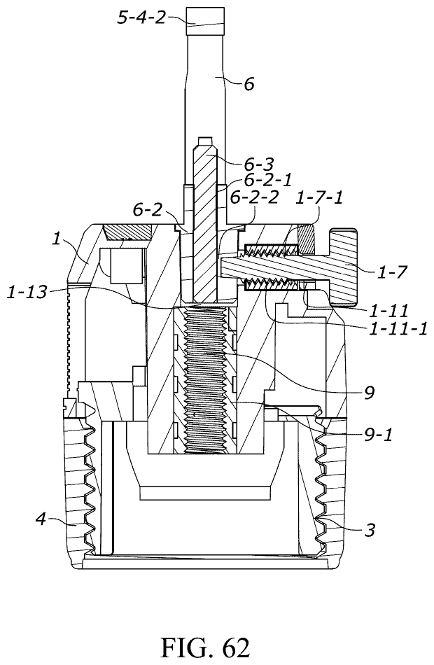

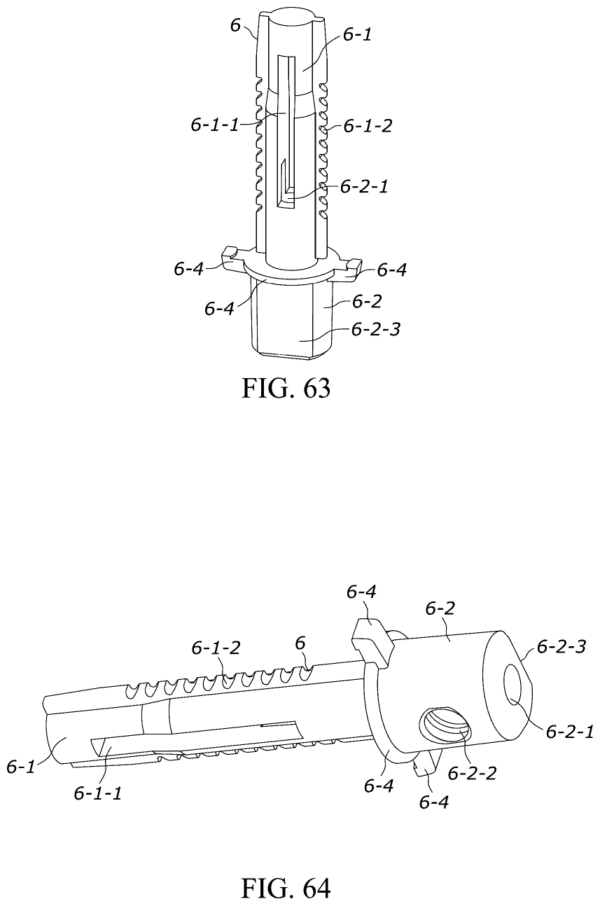

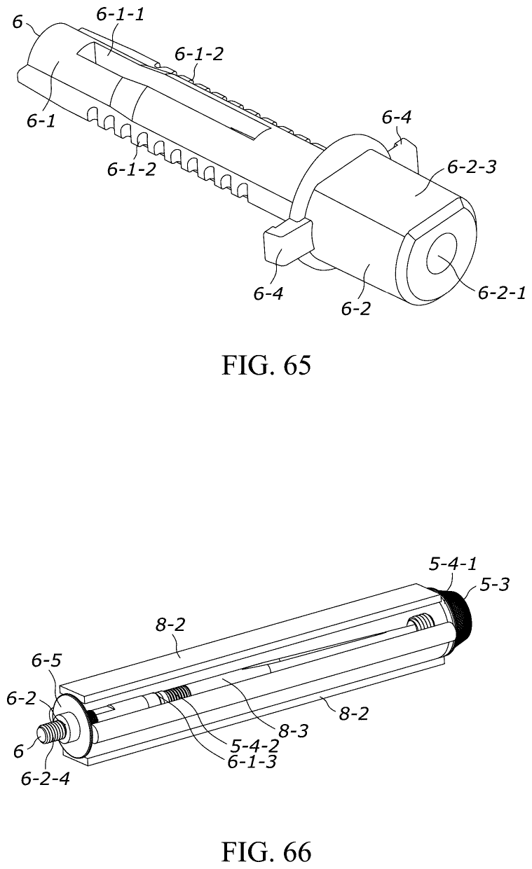

FIG. 53 to FIG. 65 depict an embodiment of a knife sharpener. The knife sharpener includes the angle gauge with an adjustable angle in the above embodiments. In this embodiment, a first knob 1-7 is arranged in a radial direction of a first support 1 corresponding to a first connecting groove 1-13, a connecting section B 6-2 is provided with a third mounting hole 6-2-2 in the radial direction and a third axial hole 6-2-1 for mounting a metal insert 6-3, and after the connecting section B 6-2 is embedded in the first connecting groove 1-13, the third mounting hole 6-2-2 matches the first knob 1-7 to achieve a connection between a third connecting member 6 and the first support 1.

The metal insert 6-3 may be a cylindrical metal strip, for example, an iron shaft or a stainless steel shaft. After a connecting section A 6-1 is embedded in a knife sharpening support 5 (for example, inside a bottom end of a tapered rod receiving hole 5-2-1), the metal insert 6-3 is embedded in the third axial hole 6-2-1. The third axial hole 6-2-1 may extend into the connecting section A 6-1 (for example, in communication with a third hollowed-out portion 6-1-1). The presence of the metal insert 6-3 increases a radial pressure between the third connecting member 6 (that is, the connecting section A 6-1) and the knife sharpening support 5 (for example, inside the bottom end of the tapered rod receiving hole 5-2-1), thereby preventing the third connecting member 6 from falling off the knife sharpening support 5. In addition, the strength of the third connecting member 6 (especially the connecting section B 6-2) is also enhanced, and the connecting section B 6-2 is not prone to accidental breakage.

A first guide groove 1-5 and the first knob 1-7 are opposite to each other in pairs and respectively correspond to cowhides 8-2 on the knife sharpening support 5 (that is, the first guide groove 1-5 corresponds to a cowhide 8-2 for sharpening a knife, and the first knob 1-7 corresponds to the other cowhide 8-2 for sharpening a knife).

An outer side surface of the connecting section B 6-2 is provided with a positioning surface B 6-2-3. An inner side wall of the first connecting groove 1-13 is provided with a positioning surface A 1-13-1. The positioning surface A 1-13-1 matches the positioning surface B 6-2-3 to prevent incorrect mounting. In other words, before the connecting section B 6-2 is embedded in the first connecting groove 1-13, the positioning surface B 6-2-3 of the connecting section B 6-2 corresponds to the positioning surface A 1-13-1 of the first connecting groove 1-13, and then is embedded in the first connecting groove. In this way, it may be ensured that after the two positioning surfaces are mounted, the knife sharpening support 5 and the first support 1 are mounted in accurate positions (that is, the angle gauge corresponds to a corresponding knife sharpening rod 8-1 on a knife sharpening portion), thereby improving assembly efficiency. In addition, the positioning surface A 1-13-1 and the positioning surface B 6-2-3 can further prevent the connecting section B 6-2 from rotating, and play a role of stopping rotation, so as to ensure that the angle gauge always corresponds to the corresponding knife sharpening rod 8-1 on the knife sharpening portion during use of the knife sharpener.

The first knob 1-7 includes a first knob cap 1-7-3 and a screw rod 1-7-4. An end of the screw rod 1-7-4 is connected to the first knob cap 1-7-3. An outer side wall of the first knob cap 1-7-3 is provided with a second external thread 1-7-1. The first support 1 is provided with a first through hole 1-11 for mounting the first knob 1-7. An inner side wall of the first through hole 1-11 is provided with a second internal thread 1-11-1. In this case, the second external thread 1-7-1 matches the second internal thread 1-11-1. Through rotation of the first knob 1-7, the first knob 1-7 runs through the first through hole 1-11 and then is embedded in the third mounting hole 6-2-2. After the first knob 1-7 is tightened, the first knob 1-7 and the third mounting hole 6-2-2 act together to limit axial movement (that is, axial limiting) of the third connecting member 6, to achieve a connection between the first support 1 and the knife sharpening support 5. In addition, after the first knob 1-7 is tightened, the first knob 1-7 can further clamp the connecting section B 6-2 in cooperation with the inner side wall of the first connecting groove 1-13, to fix a position of the connecting section B 6-2 in a radial direction and prevent the connecting section B 6-2 from shaking in the radial direction. In other words, limiting of the connecting section B 6-2 in both an axial direction and the radial direction is realized through the first knob 1-7. In addition, the screw rod 1-7-4 between the second external thread 1-7-1 and the first knob cap 1-7-3 is further provided with a second limiting portion 1-7-2. All of the second limiting portion 1-7-2, the screw rod 1-7-4, and the first knob cap 1-7-3 realize a structure in which two ends are large and the middle is small. A limiting structure is formed between the second limiting portion 1-7-2 and an opening portion of the first through hole 1-11. The first knob cap 1-7-3 is located outside the first support 1, and the second limiting portion 1-7-2 is located inside the first support 1 (that is, inside the first through hole 1-11). No matter how the first knob 1-7 rotates, the first knob is not detached from the first through hole 1-11, which avoids loss of the first knob 1-7. An outer side surface of the first knob cap 1-7-3 is provided with a second anti-slip portion 1-7-5. For example, the second anti-slip portion 1-7-5 adopts a mesh anti-slip pattern to facilitate tightening or loosening of the first knob 1-7 more effectively. When limiting is formed between the second limiting portion 1-7-2 and the opening portion of the first through hole 1-11, the first knob 1-7 cannot be pulled out. In this case, it may also effectively prompt that the first knob 1-7 has been completely removed from the third mounting hole of the third connecting member 6, and the knife sharpening support 5 may be detached from the first support 1.

A top portion of the first support 1 is further provided with a first limiting groove 1-10. A third limiting protrusion 6-4 for abutting against the knife sharpening rod 8-1 and/or a tapered rod 8-3 in a receiving hole 5-2 is arranged at a joint of the connecting section A 6-1 and the connecting section B 6-2. The third limiting protrusion 6-4 matches the first limiting groove 1-10. In other words, after the first support 1 and the third connecting member 6 are mounted, the third limiting protrusion 6-4 is embedded in the first limiting groove 1-10, which can effectively prevent the third connecting member 6 from rotating, fix an angle of the third connecting member 6, and finally ensure that the knife sharpening rod 8-1 of the knife sharpening portion can always correspond to a first inclined surface 2-1 of the angle gauge. In addition, the third limiting protrusion 6-4 can be further configured to abut against the knife sharpening rod 8-1 and/or the tapered rod 8-3 in the receiving hole 5-2, to prevent the knife sharpening rod 8-1 and/or the tapered rod 8-3 from sliding out of a bottom end of the receiving hole 5-2. In addition, the third limiting protrusion 6-4 does not completely cap an end portion of the receiving hole 5-2, which is convenient for a user to observe whether the knife sharpening rod 8-1 and/or the tapered rod 8-3 is arranged in the corresponding receiving hole 5-2.

The third connecting member 6 may be made of metal.

A third buffer portion 6-6, for example, a silicone buffer pad, configured to abut against the knife sharpening rod 8-1 is arranged at the joint of the connecting section A 6-1 and the connecting section B 6-2 of the third connecting member 6, to avoid a collision between the knife sharpening rod 8-1 and the third connecting member 6 more effectively and avoid noise. In this case, the third knob 5-3 may be directly pressed on the knife sharpening rod 8-1 to compress the knife sharpening rod 8-1, but the third knob 5-3 is not pressed on the knife sharpening support 5, so that the knife sharpening rod 8-1 has no movement gap and noise is avoided.

A third hollowed-out portion 6-1-1 is provided inside the connecting section A 6-1. An outer side surface of the connecting section A 6-1 is provided with a third jagged portion 6-1-2. During the mounting of the third connecting member 6 and the knife sharpening support 5, the third hollowed-out portion 6-1-1 is pressed, so that the connecting section A 6-1 can be embedded in the knife sharpening support 5 (for example, the tapered rod receiving hole 5-2-1) more effectively. When the connecting section A 6-1 is embedded in the knife sharpening support 5, the connecting section A 6-1 uses elasticity thereof to restore a shape of the third hollowed-out portion 6-1-1. The third jagged portion 6-1-2 increases a frictional force between the connecting section A 6-1 and an inner side wall of the knife sharpening support 5 (for example, the tapered rod receiving hole 5-2-1), to enhance connection strength between the third connecting member 6 and the knife sharpening support 5.

FIG. 66 depicts an embodiment of a knife sharpener. The knife sharpener includes the angle gauge with an adjustable angle in the above embodiment. In this embodiment, a third connecting member 6 may be made of metal, a connecting section A 6-1 of the third connecting member 6 is a circular structure as a whole, and an outer side surface of the connecting section A 6-1 is provided with anti-slip teeth 6-1-3. When the connecting section A 6-1 is embedded in a knife sharpening support 5 (for example, a tapered rod receiving hole 5-2-1), the anti-slip teeth 6-1-3 are fixed to inside of the knife sharpening support 5 (for example, the tapered rod receiving hole 5-2-1) by riveting, to avoid slippage between the third connecting member 6 and the knife sharpening support 5.

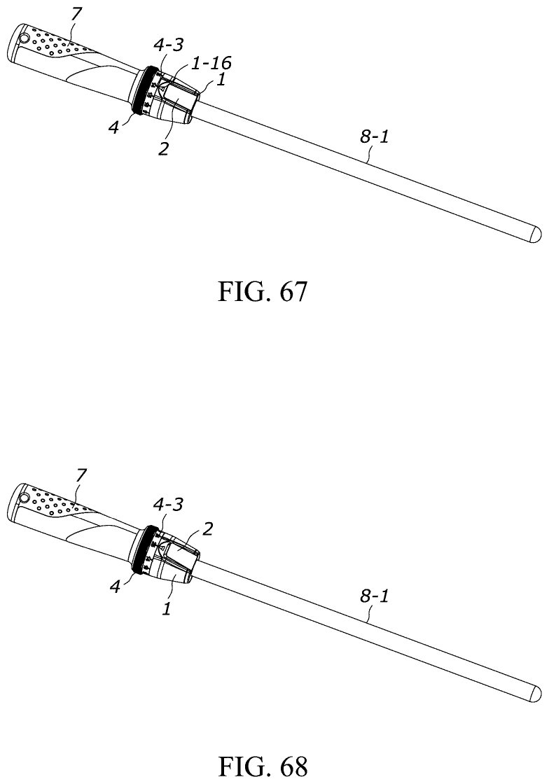

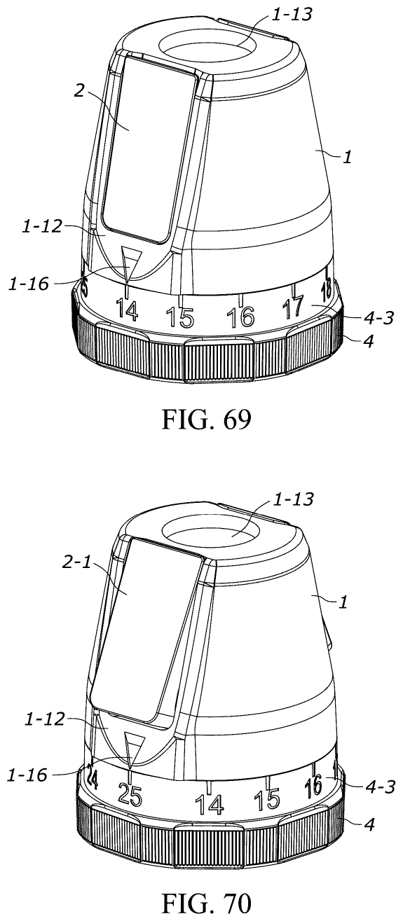

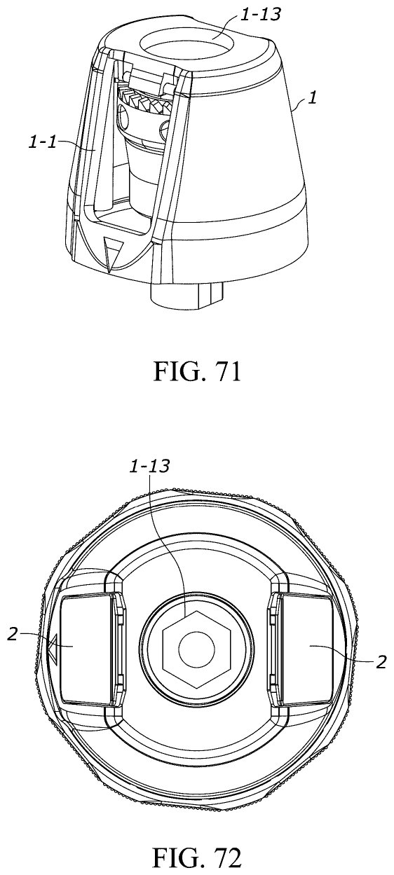

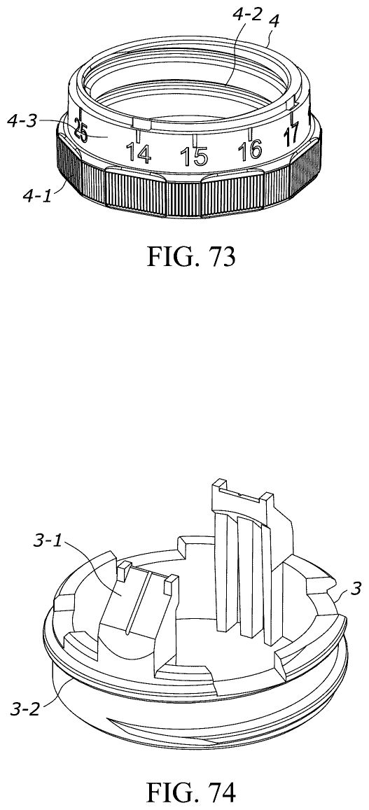

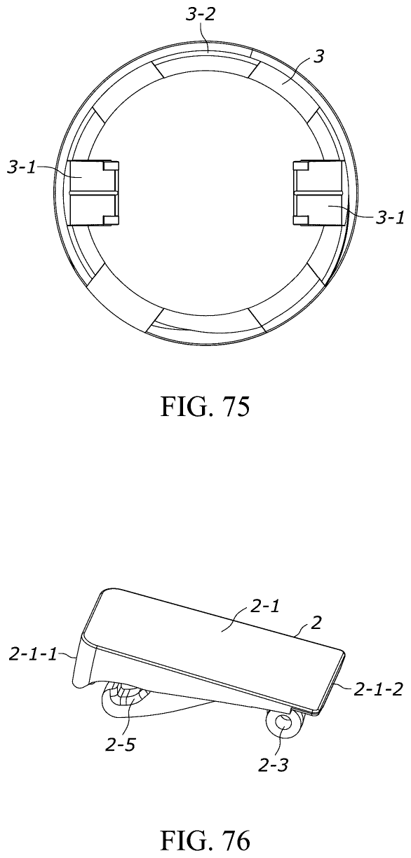

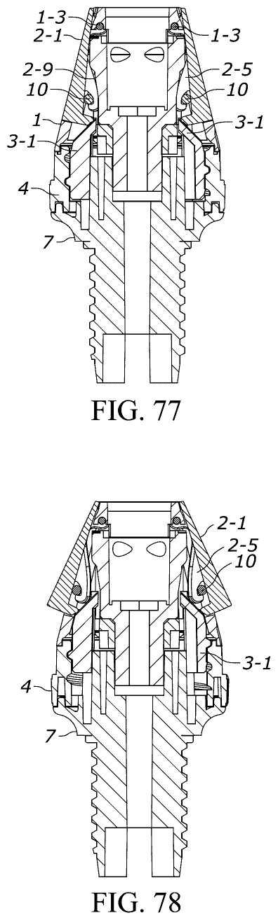

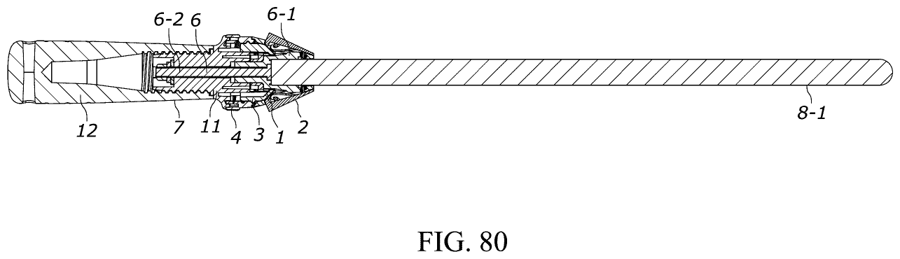

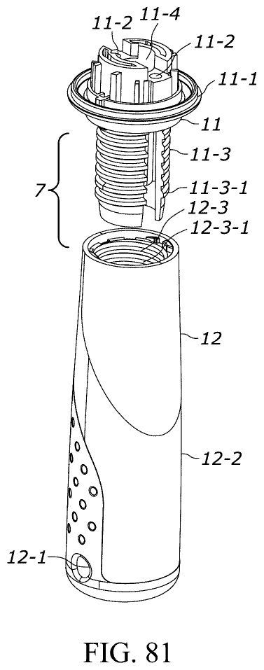

FIGS. 67-81 depict an embodiment of an angle gauge and knife sharpener. This embodiment of an angle gauge with an adjustable angle shares many elements of the angle gauge depicted in FIGS. 16-28 with two first inclined surface-equipped members 2 instead of four first inclined surface-equipped members 2.

In this embodiment, a push tube 3 is provided with four second inclined surfaces 3-1. Each of the second inclined surfaces 3-1 corresponds to one first inclined surface-equipped member 2. Two first inclined surface-equipped members 2 are distributed on two sides of a first support 1, for example, on two sides of a top end of the first support 1 or in two directions, to more fully utilize the knife sharpening portion of the knife sharpening rod to sharpen the knife.

The two first inclined surface-equipped members 2 are all connected to the fourth clastic member 10 (for example, an O-shaped elastic ring). When the push tube moves in a reverse direction, the two first inclined surface-equipped members 2 are automatically reset synchronously under the action of the fourth elastic member 10, and the first inclined surface-equipped members 2 automatically retract into a first mounting groove 1-1. For example, a bottom portion of each first inclined surface-equipped member 2 is provided with a hook 2-5, and the same fourth elastic member 10 (for example, an O-shaped elastic ring) is hooked onto hooks 2-5 of the two first inclined surface-equipped members 2.

The first support 1 is provided with an indication portion 1-16. An outer side surface of a first angle adjustment knob 4 is provided with a third identifier 4-3. The indication portion 1-16 cooperates with the third identifier 4-3. The third identifier 4-3 includes an identifier of a rotation direction of the first angle adjustment knob 4 and/or an identifier of a rotation angle value of the first angle adjustment knob 4, which are configured to display the rotation direction and/or the rotation angle value of the first angle adjustment knob (4). A user may select the rotation direction of the first angle adjustment knob 4 based on the third identifier 4-3, to quickly adjust an inclination angle of a first inclined surface 2-1. Different angle values of the third identifier corresponding to the indication portion 1-16 help the user quickly determine a rotation amplitude of the first angle adjustment knob 4.

In an embodiment, the angle gauge includes a set of angle adjustment mechanisms. The set of angle adjustment mechanisms includes a first support 1, a first inclined surface-equipped member 2, and an angle adjustment member. The first inclined surface-equipped member 2 is provided with a first inclined surface 2-1. The angle adjustment member is provided with a second inclined surface 3-1. The first inclined surface-equipped member 2 is rotatably connected to the first support 1. Through movement of the angle adjustment member, the second inclined surface 3-1 drives an end of the first inclined surface-equipped member 2 to rise or fall, to adjust an inclination angle of the first inclined surface 2-1. The first inclined surface 2-1 provides different initial angles for sharpening a knife on a knife sharpening rod.

Further, the second inclined surface 3-1 drives a bottom portion of a higher end 2-1-1 of the first inclined surface on the first inclined surface-equipped member 2 to rise or fall, to adjust the inclination angle of the first inclined surface 2-1.

A joint of the first inclined surface-equipped member 2 and the first support 1 is close to a lower end 2-1-2 of the first inclined surface.

The angle adjustment member moves from a higher position to a lower position of the first inclined surface 2-1, so that the bottom portion of the first inclined surface-equipped member 2 corresponding to the higher end 2-1-1 of the first inclined surface is gradually raised along the second inclined surface 3-1, and the inclination angle of the first inclined surface 2-1 gradually increases. The angle adjustment member moves from the lower position to the higher position of the first inclined surface 2-1, so that the bottom portion of the first inclined surface-equipped member 2 corresponding to the higher end 2-1-1 of the first inclined surface gradually falls along the second inclined surface 3-1, and the inclination angle of the first inclined surface 2-1 gradually decreases.

The first inclined surface-equipped member 2 and the angle adjustment member may be wedge-like members or wedges, or may be bodies in another shape provided with corresponding inclined surfaces that can achieve corresponding functions of two inclined surfaces.

The knife sharpener includes the angle gauge with an adjustable angle described in the above embodiments. A first support 1 is connected to a knife sharpening portion. A first inclined surface 2-1 provides a knife sharpening angle for a knife of the knife sharpening portion; that is, the first inclined surface 2-1 provides the knife sharpening angle for sharpening a knife on the knife sharpening portion. The knife sharpening portion includes a knife sharpening rod 8-1 which connects to the first support 1 through a third connecting member 6.

An injection molded member may be selected as the third connecting member 6. The third connecting member 6 is divided into a connecting section A 6-1 and a connecting section B 6-2. The connecting section A 6-1 is embedded in an end of the knife sharpening rod 8-1, to achieve the connection between the third connecting member 6 and the knife sharpening rod 8-1. The connecting section B 6-2 of the third connecting member 6 detachably connects the third connecting member 6 to the handle 7. In an embodiment, an outer side surface of the connecting section B 6-2 of the third connecting member 6 may include an external thread to connect to the handle 7. In an embodiment, connecting section B 6-2 comprises other attachment means to connect to the handle 7.

The connecting section A 6-1 of the third connecting member 6 is in a shape of a cylindrical rod body and may comprise a conic top portion. In an embodiment, the outer side surface of the connecting section A 6-1 includes a ribbed portion. To form a connection between the connecting member 6 and the sharpening rod 8-1, the connecting section A 6-1 is embedded within a hollow interior portion of the sharpening 8-1.

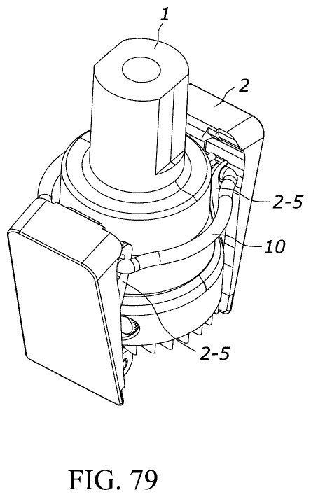

The first support 1 is connected to an end of a handle 7. The handle 7 comprises a mounting portion 11 and a gripping portion 12 which are detachably connected. The first support 1 is connected to the mounting portion 11 of the handle 7 via the third connecting member 6. The mounting portion 11 comprises a first receiving portion 11-4 at one end of the mounting portion 11. The first receiving portion 11-4 accepts the bottom portion of the first support 1. When the connection is formed between the handle 7 and first support 1, the bottom portion of the first support 1 (depicted in FIG. 79) is disposed within the first receiving portion 11-4.

The mounting portion 11 further comprises an engaging portion 11-3 at another end of the mounting portion 11. The engaging portion 11-3 connects to a gripping portion 12 of the handle 7 via a receiving portion 12-3. Along the outer surface of the engaging portion 11-3 is an external threading 11-3-1. The receiving portion 12-3 of the gripping portion 12 comprises a corresponding threading 12-3-1 which is aligned in registration with the external threading 11-3-1. The gripping portion 12 further comprises a textured portion 12-2 along the outer surface of the gripping portion 12 for a user to hold when using the knife sharpener. The gripping portion 12 may further comprise a through hole 12-1 for a wrist-strap. The wrist-strap (not shown) may be worn around a user's wrist for improved handling of the knife sharpener.

The mounting portion 11 facilitates attaching the handle 7 to the first support 1. For example, the third connecting member 6 is connected at connected section A 6-1 to the sharpening rod 8-1. The connecting member 6 travels through and is disposed within the first connecting groove 1-13. The first connecting groove 1-13 extends to the bottom of the first support 1 which is partially disposed within the first receiving portion 11-4 of the mounting portion 11 of the handle 7. The third connecting member 6 exits the first connecting groove 1-13 and extends to the end of the mounting portion 11, proximate the gripping portion 12. Connecting section B 6-2 may comprise an external threaded portion which may be fastened to a washer. The washer prevents the third connecting member 6 from withdrawing from the mounting portion 11 and/or first connecting groove 1-13 thereby connecting the third connecting member 6 to the handle 7.

The mounting portion 11 further comprises a positioning groove 11-1 which forms a rail that is contiguous with the bottom of the adjustment knob 4. The adjustment knob 4 slides along the positioning groove 11-1 as a user rotates the adjustment knob 4. The mounting portion 11 may further comprise at least one mounting hole 11-2 along a top end of the mounting portion 11. If additional support is required to mount the mounting portion 11 to the first support 1, fastener(s) may be used with the mounting hole(s) 11-2 to secure the mounting portion 11 to the first support 1.

In this case, the positioning groove 11-1 limits a bottom portion of the angle adjustment knob 4 such that when the first angle adjustment knob 4 rotates, the first angle adjustment knob 4 does not move in the axial direction, which ensures precision of axial movement of the push tube 3. The top portion of the first angle adjustment knob 4 abuts against a bottom portion of the first support 1, which may prevent the first angle adjustment knob 4 from shaking, and reduce a shaking gap between the first angle adjustment knob 4 and the push tube 3, so that the axial movement of the push tube 3 is always coaxial with a center or an axis of the handle 7. The top portion of the first angle adjustment knob 4 is disposed between the first support 1 and the handle 7. The first angle adjustment knob 4 drives the push tube 3 to achieve axial movement via the threaded connection between the angle adjustment knob 4 and push tube 3.

The top portion of the handle 7 (proximate the top of the mounting portion 11) may be further configured to abut against the interior of the push tube 3 to restrict movement of the push tube 3 in the axial direction. In other words, the bottom portion of the push tube 3 is axially limited by the mounting portion 11 of the handle 7, to avoid damage to a first protruding block 3-3 as a result of forcible and excessive rotation of the first angle adjustment knob 4 by a user.

The above descriptions are merely the preferred embodiments of the present disclosure, and are not intended to limit the scope of the present disclosure. Any equivalent structure or equivalent process transformation made by using the specification and the content of the accompanying drawings of the present disclosure or direct or indirect application to other related technical fields are encompassed in the protection scope of the present disclosure.

What is claimed is:

1. An angle gauge with an adjustable angle, wherein the angle gauge comprises
an angle adjustment mechanism, the angle adjustment mechanism comprising:
a first support,
a first inclined surface-equipped member, and
an angle adjustment member,
wherein, the first inclined surface-equipped member includes a first inclined surface for sharpening a knife, and the angle adjustment member is provided with a second inclined surface; and
wherein, the first inclined surface-equipped member is rotatably connected to the first support, and through movement of the angle adjustment member, the second inclined surface drives an end of the first inclined surface-equipped member to adjust an inclination angle of the first inclined surface.

2. The angle gauge with an adjustable angle according to claim 1, wherein the angle gauge further comprises:
a first angle adjustment knob,
wherein, the angle adjustment member is a push tube, and the first angle adjustment knob and the push tube are threadedly connected to achieve axial movement of the push tube.

3. The angle gauge with an adjustable angle according to claim 2, wherein:
the first inclined surface-equipped member comprises a higher end and a lower end and the second inclined surface engages the bottom portion of a higher end to adjust the inclination angle of the first inclined surface;
the first support has a hollow interior and includes a first mounting groove,
the first inclined surface-equipped member is partially disposed within the first mounting groove and connected to a connecting shaft; and
the outer side surface of the push tube includes a first external thread,
the top portion of the push tube is disposed within the hollow portion of the first support such that the second inclined surface is in contact with the first inclined surface-equipped member, and
the first angle adjustment knob comprises a first internal thread and is aligned in registration with the first external thread.

4. The angle gauge with an adjustable angle according to claim 3, wherein:
the first support further comprises:
a first elastic member configured to drive the first inclined surface-equipped member to a reset position;
a hollowed-out first guide groove;
a first identifier displaying an angle value adjacent a side of the first guide groove;
a second identifier displaying a rotation direction for the first angle adjustment knob, the second identifier adjacent a side of the first guide groove;
a first connecting groove disposed along the top of the first support; and
the push tube further comprises a first protruding block which is partially disposed within the first groove guide and moves in synchrony within the first guide groove with the axial movement of the push tube.

5. The angle gauge with an adjustable angle according to claim 3, wherein the first support further comprises:
a first elastic member configured to drive the first inclined surface-equipped member to a reset position;
an indication portion proximate a bottom edge of the first support corresponding to a third identifier disposed along the outer side surface of the first angle adjustment knob; and
a first connecting groove disposed along the top of the first support.

6. The angle gauge with an adjustable angle according to claim 2, wherein the push tube includes two second incline surfaces, and each of the second inclined surfaces engages with a first inclined surface-equipped member.

7. The angle gauge with an adjustable angle according to claim 2, wherein the push tube includes four second inclined surfaces, and each of the second inclined surfaces engages a first inclined surface-equipped member.

8. The angle gauge with an adjustable angle according to claim 7, wherein the four first inclined surface-equipped members are all connected to a fourth elastic member.

9. The angle gauge with an adjustable angle according to claim 1, wherein the first support is provided with a plurality of first positioning grooves, the angle adjustment member is a push block, the push block is provided with an elastic pressing portion, the elastic pressing portion is connected to a bump, and the bump matches the corresponding first positioning groove to achieve positioning of the push block after movement.

10. The angle gauge with an adjustable angle according to claim 9, wherein:
a second elastic member is disposed between the push block and the elastic pressing portion;
a first identifier displaying an angle value adjacent a side of the plurality of first positioning grooves;
the first inclined surface-equipped member includes an extension, the extension is connected to an end of a third elastic member, and a second end of the third elastic member abuts against an inner side wall of the first support; and
the elastic pressing portion is embedded in a first guide groove.

11. The angle gauge with an adjustable angle according to claim 1, wherein the angle gauge comprises n sets of angle adjustment mechanisms, wherein n is a value of between 2 and 8.

12. A knife sharpener, comprising:
an angle gauge with an adjustable angle, wherein the angle gauge comprises:
a first support;
a first inclined surface-equipped member; and
an angle adjustment member;
wherein, the first inclined surface-equipped member includes a first inclined surface for sharpening a knife, and the angle adjustment member is provided with a second inclined surface; and
wherein, the first inclined surface-equipped member is rotatably connected to the first support, and through movement of the angle adjustment member, the second inclined surface drives an end of the first inclined surface-equipped member to adjust an inclination angle of the first inclined surface; and
a knife sharpening portion;
wherein the first support (1) is connected to the knife sharpening portion, and the first inclined surface (2-1) is configured to provide a knife sharpening angle for sharpening a knife on the knife sharpening portion.

13. The knife sharpener according to claim 12, wherein:
the knife sharpening portion comprises:
a knife sharpening support; and
a knife sharpening rod;
wherein, the knife sharpening support includes:
an open groove for mounting the knife sharpening rod;
a receiving space for storage of the knife sharpening rod within the knife sharpening support;
a third knob proximate the top end of the knife sharpening support and abutting the knife sharpening rod; and
a layer of cowhide on an outer surface of the knife sharpening support; and
wherein, a bottom end of the knife sharpening support is connected to the first support via a third connecting member.

14. The knife sharpener according to claim 13, wherein:
the knife sharpening support further comprises:
two layers of cowhide on opposing surfaces of the knife sharpening support;
two open grooves adjacent each layer of cowhide;
a receiving hole disposed within and extending through the knife sharpening support;
wherein the receiving hole includes a first end and a second end; and
wherein a tapered rod receiving hole is detachably connected to the third knob at a first end of the receiving hole, and the third connecting member is connected to the second end of the receiving hole;
the third connecting member is divided into a connecting section A and a connecting section B, wherein connecting section A is embedded within the second end of the receiving hole to form the connection between the third connecting member and the knife sharpening support; and
connecting section A comprises an outer side surface selected from a group consisting essentially of: a third jagged portion, anti-slip teeth, and a knurled portion.

15. The knife sharpener according to claim 14, further comprising:
a first knob projecting from the first support in a radial direction and aligned in registration with a third mounting hole to form a connection between the third connecting member and the first support; and
a first through hole extending from a side surface of the first support to the first connecting groove, wherein the first through hole has a second internal thread;
wherein, the first knob comprises:
a first knob cap connected to an end of a screw rod;
a second external thread disposed along an outer side wall of the first knob cap; and
wherein the second external thread is aligned in registration with the second internal thread.

16. The knife sharpener according to claim 14, wherein a gasket is disposed between the connecting section A and the connecting section B; and
the knurled portion is located at a position on the connecting section A proximate the gasket.

17. The knife sharpener according to claim 14, wherein:
the first connecting groove includes a fourth internal thread disposed on the interior surface of the first connecting groove;
the third connecting member includes a fourth external thread disposed on the outer surface of the connecting section B;
wherein, the fourth internal thread is aligned in registration with the fourth external thread to achieve the connection between the first support and the third connecting member;
a bottom portion of the first support includes a first boss portion, and the first boss portion is embedded in an inner side wall of a top portion of the first angle adjustment knob; and
a handle is connected to a bottom portion of the first angle adjustment knob.

18. The knife sharpener according to any of claim 14, wherein:
the handle includes a fourth receiving space capable of storing the knife sharpening portion;
the end of the handle opposite the angle adjustment knob is connected to an end cap, wherein the end cap includes a plurality of arrow twisting teeth, and the arrow twisting teeth form a fourth hollowed-out portion for removing an arrowhead from a shaft of an arrow.
